(19) United States
(12) Patent Application Publication
(10) Pub. No.: US 2025/0294625 A1
(43) Pub. Date: Sep. 18, 2025

(54) CONNECTION MANAGEMENT AND RECOVERY ASSOCIATED WITH MULTIPATH SIDELINK RELAYS

(71) Applicant: InterDigital Patent Holdings, Inc., Wilmington, DE (US)

(72) Inventors: Martino M. Freda, Laval (CA); Oumer Teyeb, Montreal (CA); Tuong Duc Hoang, Montreal (CA); Ananth Kini, Conshohocken, PA (US)

(73) Assignee: InterDigital Patent Holdings, Inc., Wilmington, DE (US)

(21) Appl. No.: 18/860,087

(22) PCT Filed: Apr. 26, 2023
(86) PCT No.: PCT/US2023/019988

§ 371 Date: Oct. 25, 2024

Related U.S. Application Data
(60) Provisional application No. 63/334,813, filed on Apr. 26, 2022.
(60) Provisional application No. 63/395,017, filed on Aug. 4, 2022.
(60) Provisional application No. 63/421,725, filed on Nov. 2, 2022.
(60) Provisional application No. 63/445,434, filed on Feb. 14, 2023.
(60) Provisional application No. 63/456,918, filed on Apr. 4, 2023.

(51) Int. Cl. H04W 76/10; H04W 76/20; H04W 92/18

(52) U.S. Cl. CPC H04W 76/10; H04W 76/20; H04W 92/18

(57) ABSTRACT

Systems, methods, and instrumentalities are described hereinfor connection management and recovery associated with multipath sidelink relays. A relay wireless transmit/receive unit (WTRU) may provide a remote WTRU with RRC state information associated with the relay WTRU. The WTRU may receive configuration information indicating conditions to initiate a relay (re) selection or PC5-RRC connection to a relay WTRU. Conditions may be provided for initiating transmission over a relayed (e.g., secondary) path, where the conditions may depend on the RRC state information at the relay WTRU, a cell ID, and/or QoS.

### CROSS-REFERENCE TO RELATED APPLICATIONS

The application claims the benefit of U.S. Provisional Application 63/334,813, filed Apr. 26, 2022, U.S. Provisional Application 63/395,017, filed Aug. 4, 2022, U.S. Provisional Application 63/421,725, filed Nov. 2, 2022, U.S. Provisional Application 63/445,434, filed Feb. 14, 2023, and U.S. Provisional Application 63/456,918, filed Apr. 4, 2023, the contents of which are incorporated by reference in their entirety herein.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are described herein for connection management and recovery associated with multipath sidelink relays. A relay wireless transmit/receive unit (WTRU) may provide a remote WTRU with RRC state information associated with the relay WTRU. The WTRU may receive configuration information indicating conditions to initiate a relay (re) selection or PC5-RRC connection to a relay WTRU. Conditions may be provided for initiating transmission over a relayed (e.g., secondary) path, where the conditions may depend on the RRC state information at the relay WTRU, a cell ID, and/or QoS.

A remote WTRU (e.g., in RRC_CONNECTED) may determine whether routing may be performed to the secondary (e.g., relayed) path. Routing may be determined based on the bearer QoS, the RRC state of the relay WTRU, and/or the cell ID served by the relay. The remote WTRU may receive configuration information for multipath data transmission. The configuration information may indicate a direct path (e.g., Uu path) and/or an indirect path (e.g., via a sidelink relay, such as a relay WTRU). The remote WTRU may to receive multiple (e.g., two) split bearer thresholds for a (e.g., each) split bearer. The (e.g., each) split bearer thresholds may be associated with state information of the relay WTRU. For example, a first threshold may be associated with RRC Connected state, and a second threshold may be associated with RRC Idle or Inactive state (e.g., where the second threshold may be higher than the first threshold). The WTRU may determine the split bearer thresholds, or receive an indication of the split bearer thresholds. The remote WTRU may route data via both primary and secondary paths (e.g., via both the direct and the indirect path, such as via splitting the data between the direct and indirect path or duplicating the data to be sent over both the direct path and indirect path). For example, the remote WTRU may determine to use the first split bearer threshold, for example, based on receiving an indication that the relay WTRU is in RRC Connected. The remote WTRU may determine that a data volume associated with transmission is greater than the first split bearer threshold. Based on the determination that the data volume is greater than the first split bearer threshold associated with RRC Connected, the WTRU may transmit the data using the indirect path. For example, the remote WTRU may determine to use the second split bearer threshold, for example, based on receiving an indication that the relay WTRU is in RRC Idle/Inactive. The remote WTRU may determine that a data volume associated with transmission is greater than the second split bearer threshold. Based on the determination that the data volume is greater than the second split bearer threshold associated with RRC Inactive/Idle, the WTRU may transmit the data using the indirect path.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example user plane radio protocol stack for a layer 2 evolved WTRU-to-Network relay (PC5).

FIG. 3 illustrates an example control plane radio protocol stack for a layer 2 evolved WTRU-to-Network relay (PC5).

FIG. 4A illustrates an example of multipath, where a bearer may be served by the same cell.

FIG. 4B illustrates an example of multipath where a bearer may be served by different cells.

FIG. 5 illustrates an example of determining transmission path(s) using state information.

### DETAILED DESCRIPTION

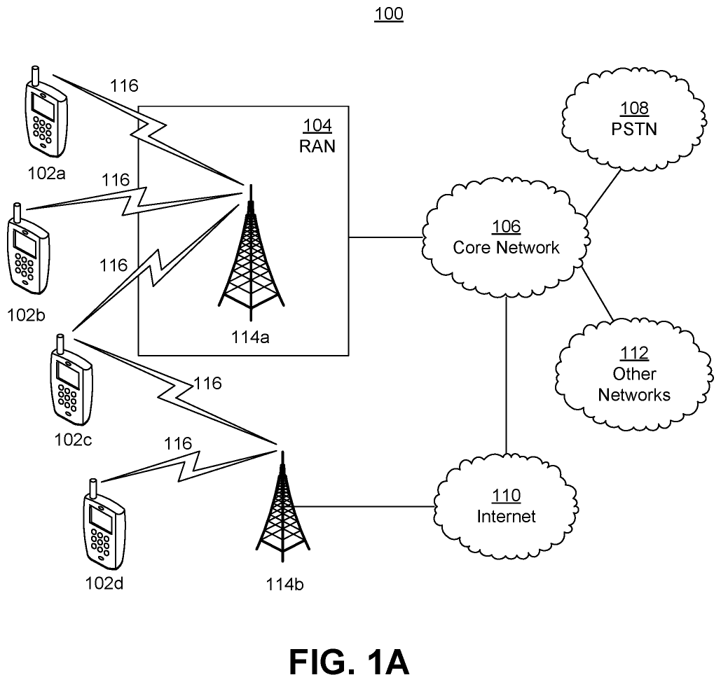

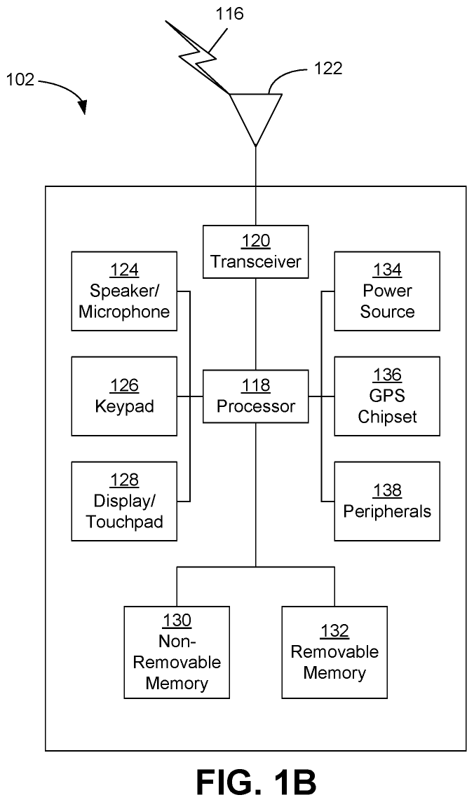

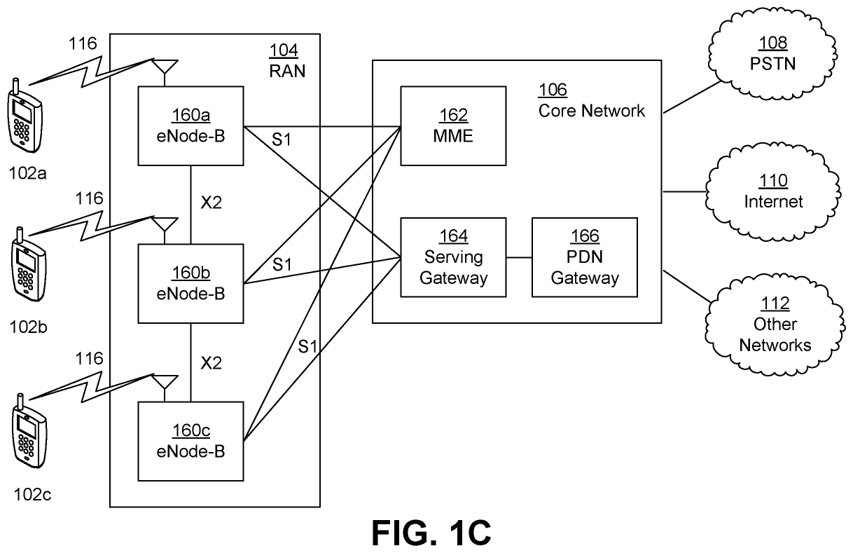

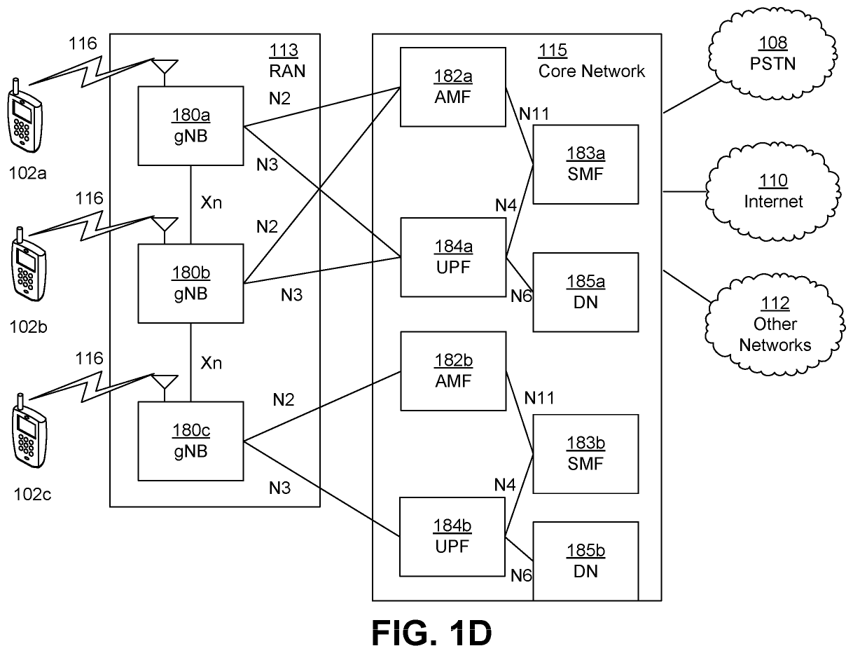

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHz, and/or 160 MHz wide channels. The 40 MHZ, and/or 80 MHz, channels may be formed by combining contiguous 20 MHZ channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Reference to a timer herein may refer to a time, a time period, a tracking of time, a tracking of a period of time, a combination thereof, and/or the like. Reference to a timer expiration herein may refer to determining that the time has occurred or that the period of time has expired.

Systems, methods, and instrumentalities are described herein for connection management and recovery associated with multipath sidelink relays. A relay wireless transmit/receive unit (WTRU) may provide a remote WTRU with RRC state information associated with the relay WTRU. The WTRU may receive configuration information indicating conditions to initiate a relay (re) selection or PC5-RRC connection to a relay WTRU. Conditions may be provided for initiating transmission over a relayed (e.g., secondary) path, where the conditions may depend on the RRC state information at the relay WTRU, a cell ID, and/or QoS.

A remote WTRU (e.g., in RRC_CONNECTED) may determine whether routing may be performed to the secondary (e.g., relayed) path. Routing may be determined based on the bearer QoS, the RRC state of the relay WTRU, and/or the cell ID served by the relay. The remote WTRU may receive configuration information for multipath data transmission. The configuration information may indicate a direct path (e.g., Uu path) and/or an indirect path (e.g., via a sidelink relay, such as a relay WTRU). The remote WTRU may to receive multiple (e.g., two) split bearer thresholds for a (e.g., each) split bearer. The (e.g., each) split bearer thresholds may be associated with state information of the relay WTRU. For example, a first threshold may be associated with RRC Connected state, and a second threshold may be associated with RRC Idle or Inactive state (e.g., where the second threshold may be higher than the first threshold). The WTRU may determine the split bearer thresholds, or receive an indication of the split bearer thresholds. The remote WTRU may route data via both primary and secondary paths (e.g., via both the direct and the indirect path, such as via splitting the data between the direct and indirect path or duplicating the data to be sent over both the direct path and indirect path). For example, the remote WTRU may determine to use the first split bearer threshold, for example, based on receiving an indication that the relay WTRU is in RRC Connected. The remote WTRU may determine that a data volume associated with transmission is greater than the first split bearer threshold. Based on the determination that the data volume is greater than the first split bearer threshold associated with RRC Connected, the WTRU may transmit the data using the indirect path. For example, the remote WTRU may determine to use the second split bearer threshold, for example, based on receiving an indication that the relay WTRU is in RRC Idle/Inactive. The remote WTRU may determine that a data volume associated with transmission is greater than the second split bearer threshold. Based on the determination that the data volume is greater than the second split bearer threshold associated with RRC Inactive/Idle, the WTRU may transmit the data using the indirect path.

A remote WTRU may determine to refrain from routing data (e.g., not to route any data) via the indirect path, for example, based on state information (e.g., based on a determination that the relay WTRU is in RRC Idle or Inactive state).

A remote WTRU may release its multipath configuration (e.g., the configuration associated with the indirect path), for example, based on state information (e.g., based on a determination that the relay WTRU is in RRC Idle or Inactive state).

Systems, methods, and instrumentalities are described herein for connection management and recovery associated with multipath sidelink relays. A wireless transmit/receive unit (WTRU) may perform operations associated with connection management and/or recovery in multipath sidelink relays. In examples, the WTRU may select path(s) to which to perform connection establishment. The WTRU may inform the network of the availability of another path during establishment. A successful connection establishment on Uu may define a PC5-RRC link behavior of the WTRU. A relay WTRU may provide a remote WTRU with RRC state information associated with the relay WTRU. The WTRU may receive configuration information indicating conditions to initiate a relay (re) selection or PC5-RRC connection to a relay WTRU. Conditions may be provided for initiating transmission over a relayed (e.g., secondary) path, where the conditions may depend on the RRC state information at the relay WTRU, a cell ID, and/or QoS. The WTRU may initiate Uu RRC message/procedure (e.g., or other procedures), for example via the relay WTRU prior to data transmission. The WTRU may initiate procedures in response to reception of a sidelink transfer indication (e.g., UuMessageTransferSidelink). The WTRU may initiate the procedures in response to detection of sidelink radio link failure (SL-RLF), for example in response to detection of SL-RLF instead of reception of UuMessageTransferSidelink. The relay WTRU may provide additional information to the remote WTRU for bearer reconfiguration and/or recovery.

A remote WTRU may perform transmission of an RRC message based on arrival conditions and knowledge of the RRC state of the relay WTRU. The remote WTRU may determine the type of RRC message, for example, based on the cell ID served by the relay, the amount of data and/or knowledge of the RRC state of the relay WTRU. The remote WTRU may be configured for multipath operation (e.g., where the WTRU may send/receive data via a direct Uu path and a SL relay path). For example, the remote WTRU may determine to operate using the multipath operation, receive an indication to operate using the multipath operation, etc. The remote WTRU may transmit and/or receive from the direct Uu path. The remote WTRU may receive state information from the relay WTRU (e.g., in a discovery message). The remote WTRU may be configured with a data buffer threshold. The data buffer threshold may be used to determine if (e.g., when) to initiate transmissions via the relay path. The remote WTRU may determine to initiate data transmission (e.g., UL UP data transmission) via the relay path based on Uu and/or SL measurements or the link status of the Uu (e.g., Uu RLF is triggered). Based on a decision to initiate data transmission, the remote WTRU may determine whether to initiate transmission of an RRC message prior to the data transmission, for example, based on the reason for the data transmission initiation (e.g., data triggered or Uu RLF), whether the relay WTRU is served by the same or different cell as the remote WTRU, and the state information from the relay (e.g., no RRC message if/when the relay WTRU is in connected, same cell case, and transmission triggered by measurements). If transmission of the RRC message is triggered, the remote WTRU may determine the type of RRC message based on whether the relay is served by the same cell and the reason for data transmission initiation (e.g., DC-like RRC message such as MCGFailure or RRCReconfigurationComplete for different cell case, and

UEAssistanceInformation/SidelinkUEInformation for same cell case). If transmission of the RRC message is successful, the remote WTRU may initiate data transmission via the relay path. Similar behavior can be applied to transmission of a Uu RRC message by the remote WTRU via the indirect path.

A remote WTRU (e.g., in RRC_CONNECTED) may determine recovery actions following reception of a Uu information message from the relay WTRU, for example, based on the type of event indicated by the relay WTRU and the bearer configuration/quality of service (QOS). The remote WTRU may be configured for multipath operation (e.g., where the WTRU may send and/or receive data via a direct Uu path and a SL relay path). For example, the remote WTRU may determine to operate using the multipath operation, receive an indication to operate using the multipath operation, etc. The remote WTRU may receive and decode a Uu information message from the relay WTRU, for example, via PC5-RRC. The remote WTRU may determine the cause/value and/or type of the message. The remote WTRU may determine bearer recover actions, whether to release the PC5-RRC connection, and/or inform the network, for example, based on the event type in the Uu information message received from the remote WTRU and the bearer configuration/QoS. The remote WTRU may suspend bearers (e.g., all bearers) configured via the relay path or relay path of split bearers and transmit data (e.g., all data) via Uu, for example, if an HO indication may be received from the relay WTRU. If a connection establishment failure or Uu RLF is received from the relay, the remote WTRU may perform the following: release bearers (e.g., all bearers) configured via the relay path or relay path of split bearers and transmit data (e.g., all data) via Uu; release the PC5-RRC connection; inform the network of the connection establishment failure or Uu RLF via an uplink Uu RRC message; etc. The remote WTRU may suspend bearers (e.g., all bearers) configured via the relay path or relay path of split bearers and inform the network of the cell reselection (e.g., via an uplink Uu RRC message), for example, if a cell reselection indication is received from the relay WTRU.

A remote WTRU (e.g., in RRC_CONNECTED) may determine whether routing may be performed to the secondary (e.g., relayed) path. Routing may be determined based on the bearer QoS, the RRC state of the relay WTRU, and/or the cell ID served by the relay. The remote WTRU may be configured to receive multiple (e.g., two) split bearer thresholds for a (e.g., each) split bearer. The WTRU may determine the split bearer thresholds, or receive an indication of the split bearer thresholds. The remote WTRU may be configured (e.g., per-bearer) with information indicating whether routing is allowed via the secondary path having a different cell ID. For example, the remote WTRU may receive the information, determine the information, etc. The remote WTRU may route data via both primary and secondary paths. For example, if the amount of data for a bearer is above a first split bearer threshold, the relay WTRU is in RRC Connected, and the cell ID serving the relay WTRU is the same as the cell ID serving the remote WTRU or for bearers that allow routing data via paths served by cells IDs. The remote WTRU may be configured to route data via both primary and secondary paths. For example, if the amount of data for a bearer is above a second split bearer threshold and if the cell ID serving the relay WTRU is the same as the cell ID serving the remote WTRU or for bearers which allow routing data via paths served by cells IDs. The remote WTRU may be configured to route data to the primary path (e.g., only the primary path), for example, otherwise.

It may be possible that the uplink transmission may be delayed and/or suspended. For example, a remote WTRU may delay and/or suspend UL transmission to ensure that a relay WTRU's connection establishment may be successful.

RRC connection may be initiated, for example, by a relay WTRU. The relay WTRU may determine a trigger associated with initiating RRC connection. For example, a trigger condition may be based on one or more of: whether multipath is configured, an indication received from a corresponding remote WTRU, or network signaling.

In multipath operation, a WTRU may determine which path to use to transmit messages (e.g., UL RRC messages). For example, a WTRU may change a primary path for transmission autonomously (e.g., based on a condition). The WTRU may change a primary path for transmission autonomously, based on a trigger (e.g., predefined trigger). The WTRU may autonomously (e.g., based on a condition) change a Pcell, while in multipath operation. The WTRU may report relays connected to one or more cells to the network. The WTRU may change the primary path of a SRB, for example, based on reception of a message from the relay WTRU. The WTRU may initiate a procedure (e.g., similar to re-establishment), associated with the Uu path, for example, based on reception of a message from the relay WTRU.

Failure procedures may be enabled, and/or implemented. Failure procedures may be associated with a message (e.g., ReconfigurationComplete message) being sent unsuccessfully. For example, a WTRU may initiate a failure procedure based on determining that a Reconfiguration Complete message was sent unsuccessfully.

Re-establishment (e.g., re-establishment procedures) may be performed. For example, re-establishment may be initiated (e.g., by a remote WTRU) based on a failed path addition. Re-establishment procedure (e.g., actions) may depend on the path selected and/or cell relationship.

Relays such as WTRU to network relays, and/or WTRU to WTRU relays (e.g., based on PC5/sidelink), may be used.

Sidelink operations (e.g., NR sidelink) may be used, for example, to support (e.g., V2X related) road safety services. Sidelink operations may provide support for broadcast, groupcast, and/or unicast communications in both out-of-coverage and in-network coverage scenarios. Sidelink-based relaying functionality may be improved, for example, including sidelink/network coverage extension and power efficiency improvement (e.g., to consider a wider range of applications and services).

Coverage extension for sidelink-based communication may be enabled. For example, coverage extension for sidelink-based communication may include WTRU-to-network coverage extension. Uu coverage reachability may be used by (e.g., may be necessary for) WTRUs to reach a server in PDN network or a counterpart WTRU out of proximity area. A WTRU-to-network relay may be limited (e.g., to EUTRA-based technology), and may not be applied to the NR-based system(s) (e.g., for both NG-RAN and NR-based sidelink communication).

For example, coverage extension for sidelink-based communication may include WTRU-to-WTRU coverage extension. Proximity reachability may use (e.g., may be limited to) a single-hop sidelink link, for example, via EUTRA-based or NR-based sidelink technology. A single-hop sidelink link may not be sufficient, for example, if there is no Uu coverage (e.g., considering the limited single-hop sidelink coverage).

Sidelink connectivity may be extended (e.g., in the NR framework), for example, to support enhanced quality of service (QOS) requirements.

Scheduling assignment (SA) requirements may be supported, for example, for sidelink-based WTRU-to-network and/or WTRU-to-WTRU relay. SA requirements may be supported, for example, focusing on one or more of the following (e.g., for layer-3 relay and layer-2 relay): relay (re-) selection criterion and procedure; relay/remote WTRU authorization; QoS for relaying functionality; service continuity; security of relayed connection (e.g., after SA3 has provided its conclusions); and impact on user plane protocol stack and control plane procedure (e.g., connection management of relayed connection).

The upper layer operations of a discovery model or procedure for sidelink relaying may be changed. This may be done for example, by assuming there may be no new physical layer channel or signal.

It may be possible to use a relay system between a wireless transceiver and a network. Relaying (e.g., via ProSe WTRU to network relays) may be used to extend network coverage to a WTRU that may be out of coverage WTRU, for example, by using PC5 (e.g., device to device (D2D) communications/links) between an out of coverage WTRU and a WTRU-to-network relay.

A WTRU-to-network relay (e.g., a ProSe WTRU-to-network relay) may provide a forwarding function (e.g., a generic L3 forwarding function) that may relay IP traffic (e.g., any type of IP traffic) between the remote WTRU and the network. One-to-one and one-to-many sidelink communications may be used between the remote WTRU(s) and the WTRU-to-network relay (e.g., a ProSe WTRU-to-network relay). For both a remote WTRU and a relay WTRU, a (e.g., only one single) carrier (e.g., a Public Safety ProSe Carrier) operation may be supported (e.g., Uu and PC5 may be the same carrier for the relay/remote WTRU). The remote WTRU may be authorized (e.g., by upper layers), and may be in-coverage of the Public Safety ProSe Carrier or out-of-coverage on any supported carriers, for example, including the Public Safety ProSe Carrier for WTRU-to-network relay discovery, (re) selection, and/or communication. The ProSe WTRU-to-Network Relay may be in-coverage (e.g., always in-coverage) of EUTRAN. The ProSe WTRU-to-network relay and the remote WTRU may perform sidelink communication and/or sidelink discovery (e.g., as described herein).

Relay selection may be performed, for example, for WTRU to network (NW) relays.

Relay selection/reselection (e.g., for ProSe WTRU to NW relays) may be performed based on a combination of (e.g., AS layer quality) measurements (e.g., RSRP) and criteria (e.g., upper layer criteria), for example, as described herein.

An eNB may control whether the WTRU may act as a ProSe WTRU-to-Network Relay. ProSe WTRU-to-Network Relay operation may be supported (e.g., in the cell), for example, if the eNB broadcasts information (e.g., any information) associated with ProSe WTRU-to-Network Relay operation. The eNB may provide one or more of the following: transmission resources for ProSe WTRU-to-Network Relay discovery (e.g., using broadcast signaling for RRC_IDLE state and dedicated signaling for RRC_CONNECTED state); reception resources for ProSe WTRU-to-Network Relay discovery (e.g., using broadcast signaling); a minimum and/or a maximum Uu link quality (RSRP) threshold(s) (e.g., via a broadcast) that the ProSe WTRU-to-Network Relay may consider (e.g., needs to respect), for example, before it may initiate a WTRU-to-Network Relay discovery procedure; etc. The WTRU may use the threshold(s) to start or stop (e.g., autonomously start or stop) the WTRU-to-Network Relay discovery procedure (e.g., in RRC_IDLE), for example, if (e.g., when) the eNB broadcasts transmission resource pools. The WTRU may use the threshold(s) to determine if it may indicate to eNB that it is a relay WTRU and wants to start ProSe WTRU-to-Network Relay discovery, for example in RRC_CONNECTED.

A WTRU can initiate a request for ProSe-WTRU-to-Network Relay (ProSeUE-to-Network relay) discovery resources (e.g., by dedicated signaling) while considering (e.g., respecting) the broadcasted threshold(s), for example, if the eNB refrains from broadcasting (e.g., does not broadcast) transmission resource pools for ProSe-WTRU-to-Network Relay discovery.

The WTRU can perform ProSe WTRU-to-Network Relay discovery (e.g., if/when in RRC_IDLE), for example, if the ProSe-WTRU-to-Network Relay is initiated (e.g., by broadcast signaling). The WTRU may perform relay discovery (e.g., as long as it is in RRC_CONNECTED), for example, if the ProSe WTRU-to-Network Relay is initiated (e.g., by dedicated signaling).

A ProSe WTRU-to-Network Relay that performs sidelink communication for ProSe WTRU-to-Network Relay (e.g., ProSe UE-to-Network Relay) operation may be (e.g., has to be) in RRC_CONNECTED. The ProSe WTRU-to-Network Relay may indicate to the eNB that the ProSe WTRU-to-Network Relay may be a ProSe WTRU-to-Network Relay and that it intends to perform ProSe WTRU-to-Network Relay sidelink communication, for example, based on (e.g., after) receiving an establishment request (e.g., layer-2 link establishment request) or monitoring request (e.g., temporary mobile group identity (TMGI) monitoring request, for example, via an upper layer message) from the remote WTRU. The eNB may provide resources for ProSe WTRU-to-Network Relay communication.

The remote WTRU can decide to monitor (e.g., when to start monitoring) for ProSe WTRU-to-Network Relay discovery. The remote WTRU can transmit ProSe WTRU-to-Network Relay discovery solicitation messages (e.g., while in RRC_IDLE or in RRC_CONNECTED), for example, depending on the configuration of resources for ProSe WTRU-to-Network Relay discovery. The eNB may broadcast a threshold, which may be used by the remote WTRU to determine if it can transmit ProSe WTRU-to-Network Relay discovery solicitation messages, for example, to connect or communicate with a ProSe WTRU-to-Network Relay WTRU. The remote WTRU (e.g., RRC_CONNECTED remote WTRU) may use the broadcasted threshold to determine if it can indicate to eNB that it is a remote WTRU and wants to participate in ProSe WTRU-to-Network Relay discovery and/or communication. The eNB may provide, transmission resources using broadcast or dedicated signaling and reception resources using broadcast signaling for ProSe WTRU-to-Network Relay operation. The remote WTRU may refrain from using (e.g., stop using) ProSe WTRU-to-Network Relay discovery and communication resources, for example, if (e.g., when) an RSRP goes above the broadcasted threshold. A time (e.g., exact time) associated with traffic switching (e.g., from Uu to PC5 or vice versa), for example, may be determined (e.g., by the higher layer).

The remote WTRU may perform measurements (e.g., radio measurements), for example, at the PC5 interface. The remote WTRU may uses the measurements for ProSe WTRU-to-Network Relay selection and reselection (e.g., along with higher layer criterion). A ProSe WTRU-to-Network Relay may be considered suitable (e.g., in terms of radio criteria), for example, if the PC5 link quality exceeds a configured threshold (e.g., pre-configured or provided by eNB). The remote WTRU may select the ProSe WTRU-to-Network Relay that satisfies criteria (e.g., a higher layer criterion) and has the best PC5 link quality (e.g., among all suitable ProSe WTRU-to-Network relays).

A remote WTRU may trigger ProSe WTRU-to-Network Relay reselection, for example, based on one or more of the following: if the PC5 signal strength of the current ProSe WTRU-to-Network Relay is below a configured signal strength threshold; if the remote WTRU receives a release message (e.g., a layer-2 link release message, such as an upper layer message), for example, from the ProSe WTRU-to-Network relay; etc.

WTRU to Network relays may be used for wearables.

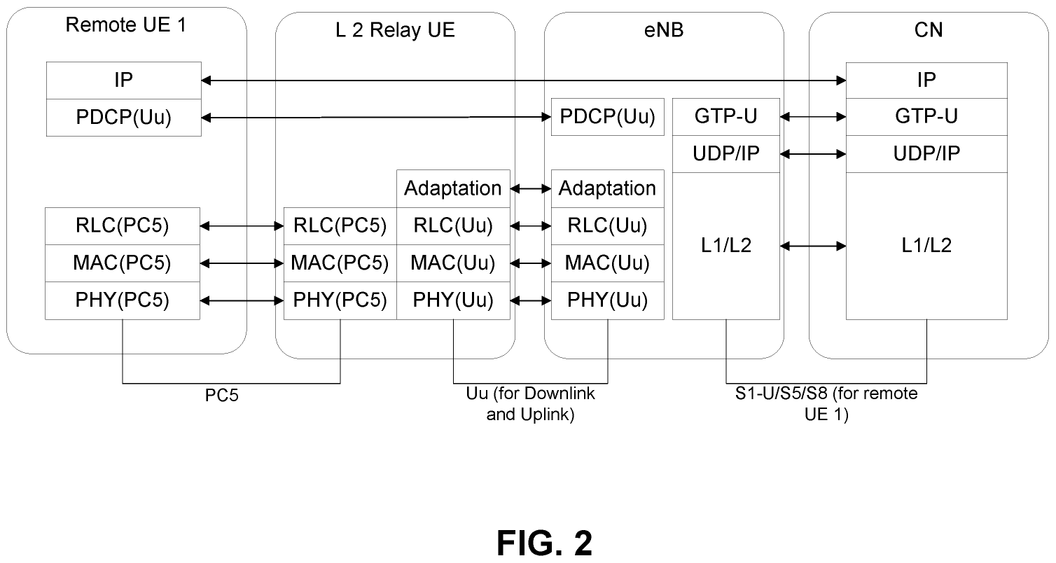

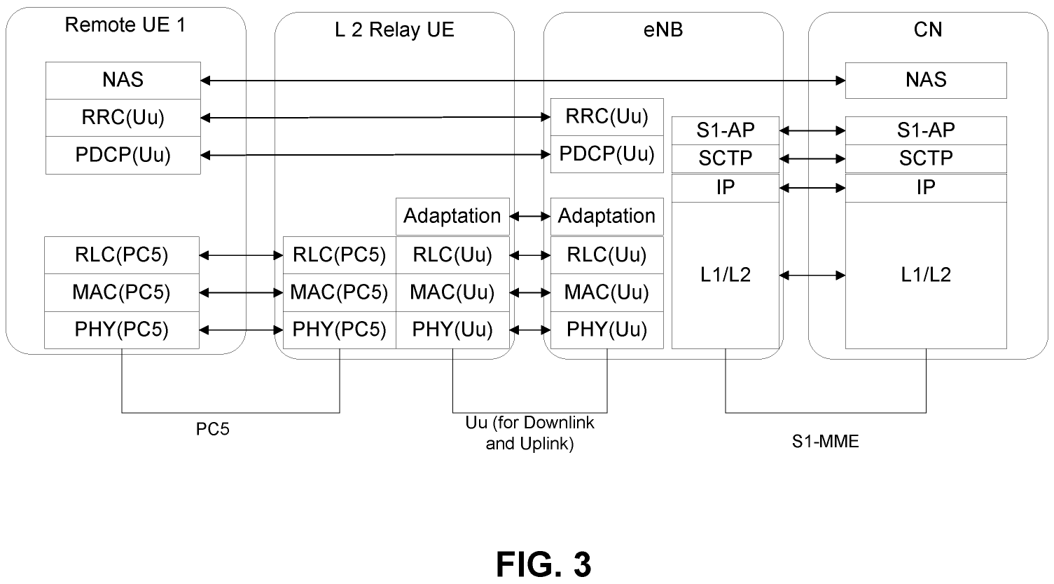

WTRU to NW relays may be used for commercial use cases tailored to wearables and IoT devices. The WTRU to NW relays for wearables may be a L2 relay (e.g., based on the protocol stacks shown in FIGS. 2 and 3), for example, contrary to ProSe WTRU to NW relays which may use a L3 (IP layer) relaying approach.

FIG. 2 illustrates an example user plane radio protocol stack for a layer 2 evolved WTRU-to-Network relay (PC5).

FIG. 3 illustrates an example control plane radio protocol stack for a layer 2 evolved WTRU-to-Network relay (PC5).

Connection establishment for unicast links (e.g., in NR V2X) may be enabled.

Relay operations may be enabled, for example, based on a one to one communication link (e.g., established at upper layers (ProSe layer) between two WTRUs (e.g., the remote WTRU and the WTRU to NW relay). Such a connection may be transparent (e.g., to the AS layer and connection management signaling) and procedures performed (e.g., at the upper layers) may be carried by data channels (e.g., AS layer data channels). For example, the AS layer may be unaware of such a one-to-one connection.

The AS layer may support a unicast link between two WTRUs (e.g., in NR V2X). Such a unicast link may be initiated (e.g., by upper layers), for example, as in the ProSe one-to-one connection. The AS layer may be informed of the presence of such unicast link and data (e.g., any data) that may be transmitted in unicast fashion between the peer WTRUs. With such knowledge, the AS layer may support HARQ feedback, CQI feedback, and/or power control schemes that may be specific to unicast.

A unicast link (e.g., at the AS layer) may be supported (e.g., possibly via a PC5-RRC connection). The PC5-RRC connection may be defined, for example, based on the following. The PC5-RRC connection may be a logical connection between a pair of a Source Layer-2 ID and a Destination Layer-2 ID (e.g., in the AS). A (e.g., one) PC5-RRC connection may correspond to a (e.g., one) PC5 unicast link. The PC5-RRC signaling may be initiated, for example, possibly based on (e.g., after) its corresponding PC5 unicast link establishment. The PC5-RRC connection and the corresponding sidelink SRBs and sidelink DRBs may be released, for example, if (e.g., when) the PC5 unicast link is released (e.g., as indicated by upper layers).

For a (e.g., each) PC5-RRC connection of unicast, a (e.g., one) sidelink SRB may be used to transmit the PC5-S message(s), for example, before the PC5-S security has been established. A (e.g., one) sidelink SRB may be used to transmit the PC5-S messages, for example, to establish the PC5-S security. A (e.g., one) sidelink SRB may be used to transmit the PC5-S message(s), for example, after the PC5-S security has been established (e.g., which may be protected). A (e.g., one) sidelink SRB may be used to transmit the PC5-RRC signaling, for example, which may be protected and sent after (e.g., only sent after) the PC5-S security has been established.

PC5-RRC signaling may include a sidelink configuration message (e.g., RRCReconfigurationSidelink), for example, where a (e.g., one) WTRU may configure the RX-related parameters of a (e.g., each) SLRB in the peer WTRU. Such a reconfiguration message may configure the parameters of each protocol, for example, in the L2 stack (e.g., SDAP, PDCP, etc). The receiving WTRU may confirm or reject such a configuration, for example, depending on whether it may support the configuration suggested by the peer WTRU.

RRC behavior/states and WTRU behavior (e.g., corresponding WTRU behavior) may be provided. A WTRU may be characterized by its behavior(s)/RRC state, for example, for the RRC state may be RRC_CONNECTED, RRC_INACTIVE, or RRC_IDLE. The WTRU behavior associated with these states may be the following. WTRU behavior associated with RRC_IDLE may include one or more of the following: PLMN selection; broadcast of system information; cell re-selection mobility; paging for mobile terminated data (e.g., which may be initiated by 5GC); DRX for CN paging (e.g., which may be configured by NAS); etc. WTRU behavior associated with RRC_INACTIVE may include one or more of the following: PLMN selection; broadcast of system information; cell re-selection mobility; paging (e.g., which may be initiated by NG-RAN), for example, such as RAN paging; RAN-based notification area (RNA) which may be managed by NG-RAN; DRX for RAN paging (e.g., which may be configured by NG-RAN); 5GC-NG-RAN connection (e.g., both C/U-planes) may be established for the WTRU; the WTRU AS context may be stored (e.g., in NG-RAN and the WTRU); NG-RAN may know the RNA which the WTRU belongs to; etc. WTRU behavior associated with RRC_CONNECTED may include one or more of the following: 5GC-NG-RAN connection (e.g., both C/U-planes) for the WTRU may be established; the WTRU AS context may be stored (e.g., in NG-RAN and the WTRU); NG-RAN may know the cell which the WTRU belongs to; transfer of unicast data to/from the WTRU; network controlled mobility (e.g., including measurements).

SL WTRU to NW relays may involve an out-of-coverage (OOC) remote WTRU. It may be possible that a remote WTRU may operate in multipath, for example, if (e.g., when) in coverage (e.g., one path over direct Uu, and another path may be via the SL WTRU to NW relay). Operating in multipath may allow for a remote WTRU to use both relayed and non-relayed paths in a more flexible manner.

For multipath, at the remote WTRU, a PDCP entity per bearer (e.g., single PDCP entity per bearer) may be configured and associated with two different RLC entities. For example, an entity may be associated with Uu, and another may be associated with SL. A (e.g., common) PDCP entity may route data to either RLC entity (e.g., similar as in dual connectivity, for example, as shown in FIG. 2.

Multipath may have differences as compared with dual connectivity (DC). For example, (e.g., in multipath), the two paths may be served by the same cell or by different cells (e.g., different scheduling entities). This may make certain DC RRC procedures unnecessary for the same cell case, or may use (e.g., require) different procedures, for example, specifically for error handling, path selection, and path configuration.

In multipath, the relayed path may undergo mobility and/or error cases at the relay WTRU, which the remote WTRU may be informed about. RRC features for these cases may be used (e.g., required), for example, that do not exist for legacy DC.

In multipath, active data transmission may be maintained, for example, while a PC5-RRC connected relay WTRU is in RRC_IDLE/RRC_CONNECTED. It may be infeasible to (e.g., always) keep the relay WTRU in RRC_CONNECTED, for example, if (e.g., when) the remote WTRU(s) have a direct path to the network. Data routing rules and state transition triggers may be used (e.g., required) to handle the relay WTRU being in different RRC states.

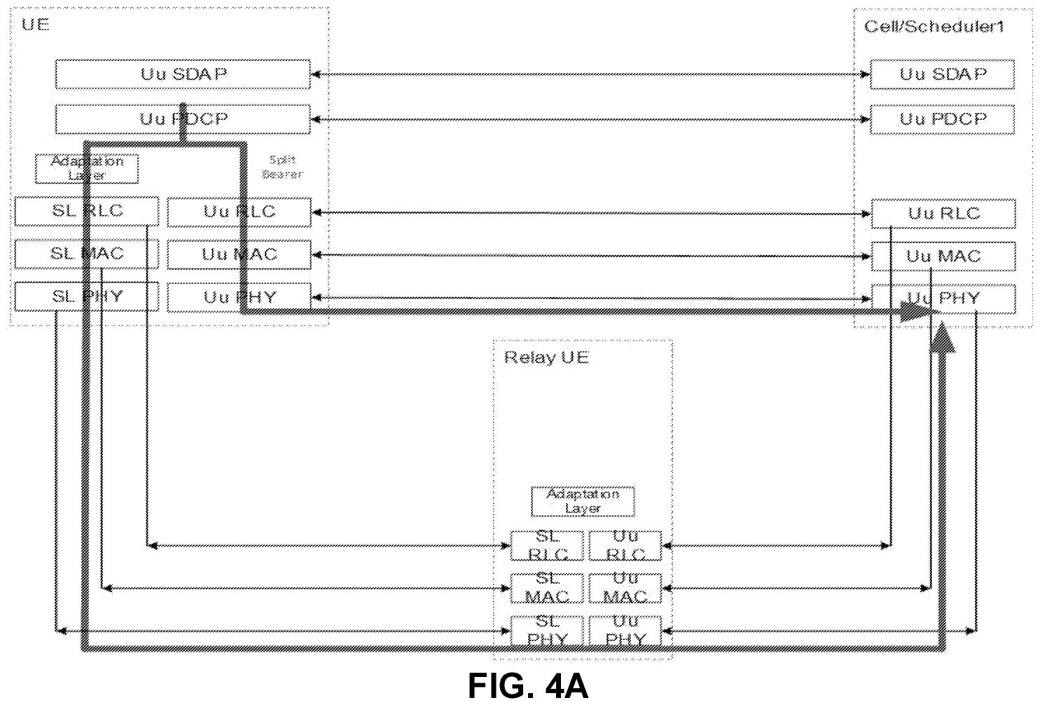

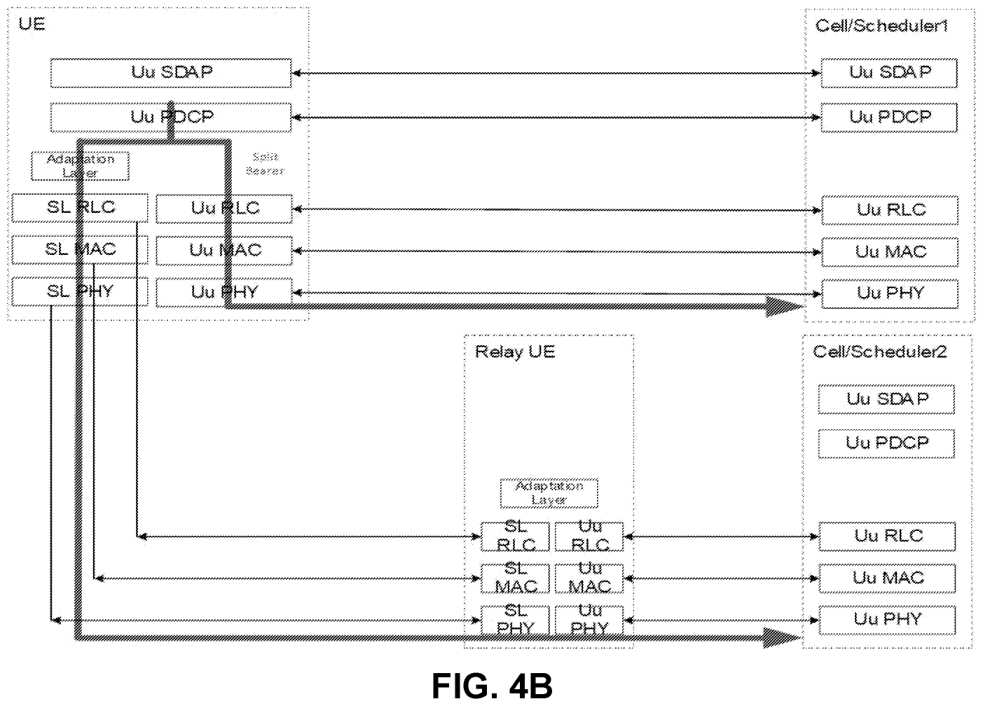

Multipath connection management may be enabled and/or performed (e.g., based on multipath configuration information). A remote WTRU in multipath may refer to a remote WTRU that may be served by a network node (e.g., gNB) or by another WTRU (e.g., in the case of V2X), for example, where the remote WTRU may send/receive data to its destination (e.g., via multiple paths). A path (e.g., one such path) may be a direct path, such as a Uu path (e.g., for the case where it may be served by a gNB), for example, if the remote WTRU is in coverage. A path (e.g., another path) may be via a SL relay (e.g., relay WTRU). In examples, the paths (e.g., direct Uu path and indirect SL path) may be indicated by configuration information, for example, as multipath data transmission information. In examples, a remote WTRU may be served by a gNB, for example, via a single Uu path and a single SL relay path (e.g., as shown in FIGS. 4A and 4B). The operations may apply with extensions to additional cases, for example, such as: multiple (e.g., more than two) paths of either direct and/or relayed; multiple paths of direct (e.g., only direct); multiple paths of relayed (e.g., only relayed); paths where the relayed path may be a multihop path; etc.

Multipath may be modelled.

For modeling of multipath, a PDCP entity (e.g., a single PDCP entity) at the WTRU may be configured with (e.g., via multipath configuration information) multiple (e.g., two) different RLC entities (e.g., one for the direct Uu path and one for the SL path via the SL WTRU to NW relay). A bearer (e.g., single bearer) configured with multiple (e.g., two) paths may be served by the same cell or different cells in the network (e.g., as shown for the two options in FIGS. 4A and 4B), for example, depending on the cell served by the relay.

FIG. 4A illustrates an example of multipath where a bearer is served by the same cell.

FIG. 4B illustrates an example of multipath where a bearer may be served by different cells.

Connection establishment procedure(s) may be performed.

A WTRU may select a path to which to perform connection establishment. In examples, a WTRU may select a path to which to initiate connection establishment, for example, based on one or more of the following: the Uu and/or SL measurements; whether a PC5-RRC connection with a relay may be established (e.g., already established) or not; the RRC state of the relay WTRU to which the remote WTRU has a PC5-RRC connection; the RRC state of the remote WTRU; the QoS and/or configuration of a bearer (e.g., any bearer) that may be configured at the remote WTRU; whether the relay WTRU may be connected to the same/different cell; etc.

For example, a WTRU may select a path to which to initiate connection establishment based on the Uu and/or SL measurements. For example, other conditions (e.g., as described herein) to select a path may depend on whether the Uu (e.g., for the direct link) and/or SL measurements (e.g., to the relay WTRU) are above a threshold. For example, the relay WTRU may broadcast (e.g., in discovery) or provide (e.g., in a PC5-RRC message) information of the measurements of its own Uu link, e.g., which may modify the conditions (e.g., as described herein) for the remote WTRU to select the Uu or relayed SL path.

For example, a WTRU may select a path to which to initiate connection establishment based on whether a PC5-RRC connection with a relay may be established (e.g., already established) or not. For example, an in coverage remote WTRU may initiate connection establishment via Uu (e.g., only), for example, unless it has a PC5-RRC connection established with a relay. In the case that a PC5-RRC connection may be established with a relay, the remote WTRU may initiate connection via either path or it may use other rules (e.g., as described herein) to determine via which path to establish a connection.

For example, a WTRU may select a path to which to initiate connection establishment based on the RRC state of the relay WTRU to which the remote WTRU has a PC5-RRC connection. For example, an in coverage remote WTRU may initiate a connection establishment via Uu (e.g., only), for example, unless the PC5-RRC connected relay WTRU is in RRC_CONNECTED. In the case of an RRC_CONNECTED relay WTRU, the remote WTRU may initiate a connection via either path or may use other rules (e.g., as described herein) to determine via which path to establish a connection.

For example, a WTRU may select a path to which to initiate connection establishment based on the RRC state of the remote WTRU. For example, a remote WTRU in RRC_INACTIVE may determine the path for connection establishment based on the QoS/configuration of the bearer (e.g., possibly the bearer whose data arrival triggered connection establishment). A remote WTRU in RRC_IDLE may refrain from using (e.g., not use) a QoS related condition (e.g., any QoS related conditions) to determine the path on which to establish an RRC connection.

For example, a WTRU may select a path to which to initiate connection establishment based on the QoS and/or configuration of a (e.g., any) bearer configured at the remote WTRU. The remote WTRU may determine the path and/or the rule to apply to select the path, for example, based on the bearers configured or the bearers on which data (e.g., UL data) has arrived. For example, the remote WTRU may be configured with bearers (e.g., specific bearers) that prioritize or allow connection via a path (e.g., only one path, for example, such as Uu only when both paths are available).

The WTRU may inform the NW of the availability of another path during establishment. In examples, a WTRU (e.g., a remote WTRU) may inform the NW of the availability of another path. Informing the NW of the availability of another path may occur by the remote WTRU during connection establishment signaling. For example, during a connection establishment/resume (e.g., which may occur via Uu), the remote WTRU may inform the network of a PC5-RRC connection with a potential relay WTRU. The remote WTRU may (e.g., alternatively) inform the network that a PC5-RRC connection was released (e.g., while the remote WTRU was in IDLE/INACTIVE) or changed (e.g., from one relay to another relay). For example, the remote WTRU may report one or more of the following information (e.g., in the complete message of a connection establishment/resume, a connection/resume request, or a similar/subsequent RRC message): the presence/absence of a PC5-RRC connection with a relay (e.g., the connection with the relay may be PC5-RRC or may be any other connection which may allow the remote WTRU to be scheduled in multipath, and such connection may be statically configured (e.g., via RRC signaling, upper layer signaling), or may be the result of a discovery operation); the relay WTRU ID (e.g., L2 ID); the cell ID to which the relay WTRU may be connected; the measurements on PC5-RRC; the RRC state of the relay WTRU; information about the protocol stack between the remote WTRU and the relay WTRU (e.g., whether an adaptation layer may be supported, the type of data splitting supported (e.g., DC-like at PDCP, LWIP like at IP layer, splitting at RLF, etc.)); etc.

A remote WTRU may inform the network of the relay WTRU connection. The remote WTRU may, for example, inform the network based on a connection establishment/resume with the network. A remote WTRU may (e.g., alternatively) inform the network based on establishment of the connection/release of the relay WTRU.

Successful connection establishment on Uu may define PC5-RRC link behavior of the WTRU. In examples, a remote WTRU with a PC5-RRC connection may maintain/release the PC5-RRC connection, e.g., based on whether Uu connection establishment may be successful and/or on other factors associated with the Uu connection establishment, such as one or more of the following: the bearer/QoS configuration (e.g., possibly obtained following connection establishment); the Uu/SL measurements; a NW indication (e.g., explicit NW indication); the cell serving the relay compared to the cell serving the remote WTRU; the RRC state of the relay WTRU; etc.

Following a connection establishment attempt by a remote WTRU via Uu, the remote WTRU may release the PC5-RRC connection, for example, if the bearers configured following establishment are such that the remote WTRU does not perform (e.g., require) maintaining the PC5-RRC connection. The remote WTRU may be configured with a set of conditions (e.g., the conditions as described herein), which may result in the remote WTRU releasing the PC5-RRC connection (e.g., after the successful establishment of the Uu RRC connection by the remote WTRU).

Path configuration procedures may be performed and/or enabled. The SL path may be enabled.

A relay WTRU may provide the relay WTRU's RRC state information (e.g., via an indication) to one or more remote WTRU(s).

The relay WTRU may transmit such state information (e.g., explicitly). For example, a relay WTRU may transmit an indication of the RRC state (e.g., a first value of indication, or no indication, for RRC_IDLE, a second value of indication, or no indication, for RRC_INACTIVE, and a third value of indication, or no indication, for RRC_CONNECTED). For example, a relay WTRU may transmit an indication (e.g., explicit indication) of whether the WTRU is in a specific RRC state or not. For example, a relay WTRU may send a first value of the indication or no indication (e.g., if the relay WTRU is in RRC_CONNECTED), and may send a second value of the indication or no indication (e.g., if the relay WTRU is not in RRC_CONNECTED).

The relay WTRU may transmit such state information (e.g., implicitly). For example, a relay WTRU may indicate to the remote WTRU one or more of the following, which may implicitly provide (e.g., indicate) the remote WTRU with the relay WTRU's RRC state. The relay WTRU may perform one or more of the following (e.g., if/when the RRC state changes): indicate to the remote WTRU whether to monitor paging via Uu or not; indicate to the remote WTRU whether to request SI to the relay or Uu; indicate to the remote WTRU whether to use a dedicated SIB request or SI request for requesting SI (e.g., via the relay); provide SL DRX configuration information and/or assistance information to the remote WTRU; indicate to the remote WTRU whether to suspend the relay path or not; etc.

The relay WTRU may (e.g., if/when the RRC state changes) indicate to the remote WTRU whether to monitor paging via Uu or not. For example, if (e.g., when) the relay WTRU moves to RRC_CONNECTED, it may indicate to the remote WTRU to monitor paging via Uu. If (e.g., when) the relay WTRU moves to RRC_IDLE/RRC_INACTIVE, the relay WTRU may indicate to the remote WTRU to refrain from monitoring (e.g., not monitor) paging via Uu and/or receive paging via SL.

The relay WTRU may (e.g., if/when the RRC state changes) indicate to the remote WTRU whether to request SI to the relay or Uu. For example, if (e.g., when) the relay WTRU moves to RRC_CONNECTED, it may indicate to the remote WTRU to request SI (e.g., directly via Uu). If (e.g., when) the relay WTRU moves to RRC_INACTIVE/RRC_IDLE, it may indicate to the remote WTRU that it may request SI via the relay WTRU.

The relay WTRU may (e.g., if/when the RRC state changes) indicate to the remote WTRU whether to use a dedicated SIB request or SI request for requesting SI (e.g., via the relay). For example, if (e.g., when) the relay WTRU moves to RRC_CONNECTED, it may indicate to the remote WTRU to request SI (e.g., via dedicatedSIBRequest). Otherwise, the relay WTRU may indicate to the remote WTRU to request SI via SI request.

The relay WTRU may (e.g., if/when the RRC state changes) provide SL DRX configuration information and/or assistance information to the remote WTRU. For example, if (e.g., when) the relay WTRU moves to RRC_IDLE/RRC_INACTIVE, it may use the configuration information (e.g., initiate a PC5-RRC configuration of SL DRX) or it may transmit assistance information for the SL DRX configuration. If (e.g., when) the relay WTRU moves to RRC_CONNECTED, it may cancel/release any previously configured SL DRX configuration.

The relay WTRU (e.g., if/when the RRC state changes) may indicate to the remote WTRU whether to suspend the relay path or not. For example, if (e.g., when) the relay WTRU moves to RRC_IDLE/RRC_INACTIVE, it may initiate a PC5-RRC message indicating that the remote WTRU should suspend the relay path of a bearer, and use (e.g., only) the Uu path. Such an indication may be used by the remote WTRU to suspend the relayed path/leg of (e.g., any) split bearer(s) or suspend (e.g., any) bearer(s) which may operate (e.g., entirely) over the relayed path. If (e.g., when) the relay WTRU moves to RRC_CONNECTED, it may initiate a PC5-RRC message to resume/enable such bearers. The remote WTRU may use such an indication as an implicit indication of the RRC state of the relay WTRU.

The relay WTRU may provide the RRC state information using one or more of the following: a discovery message, a PC5-RRC message, a control PDU (e.g., adaptation layer control PDU), an SCI, a control element (e.g., PC5 MAC CE), etc.

The relay WTRU may provide (e.g., provide periodically or regularly) the state information (e.g., such as in the transmission of a discovery message). The relay WTRU may (e.g., alternatively) provide the state information, for example, if (e.g., when) the state information (e.g., or the information as described herein) changes.

A WTRU may be configured with conditions for initiating a relay (re) selection or PC5-RRC connection to a relay WTRU.

In examples, a remote WTRU may be configured with conditions to perform a relay (re) selection, initiate a PC5-RRC connection, or initiate/use a SL relay or relayed path. Such conditions may be configured and/or satisfied, for example, if (e.g., while) the WTRU may be in coverage of Uu and/or configured with another SL relay path. Such conditions may be monitored if (e.g., while) the WTRU is in a (e.g., any) RRC state. The conditions may be associated with one or more of the following: data-based conditions (e.g., if the amount of data available for transmission at the WTRU is above a threshold, the remote WTRU may initiate a relay selection); Uu measurements and/or PC5 measurements (e.g., the remote WTRU may initiate a relay selection provided the measured Uu RSRP is below a threshold, where in examples the measurement condition(s) may be combined with the data-based conditions); Uu mobility-based triggers; etc.

The condition (e.g., to perform a relay (re) selection, initiate a PC5-RRC connection, or initiate/use a SL relay or relayed path) may be associated with Uu mobility-based triggers. For example, a remote WTRU may receive (e.g., may be configured with) conditions to initiate a relay (re) selection procedure and/or a PC5-RRC connection procedure, and/or a PC5-RRC release procedure, e.g., based on a mobility trigger (e.g., a HO, a re-establishment to a different cell, a CHO, etc). Such conditions and the corresponding WTRU behavior may depend (e.g., further depend) on the RRC state of the remote WTRU. Such conditions and the corresponding WTRU behavior may depend (e.g., further depend) on the cell ID, gNB ID, list of cells, or similar associated with the direct cell versus the cell to which the relay WTRU may be attached.

A remote WTRU in RRC CONNECTED may have a PC5-RRC connection with a WTRU that may act as a relay WTRU. The remote WTRU may release the PC5-RRC connection and initiate a relay reselection procedure, for example, based on the reception of a handover (HO) command (e.g., via the direct link). The remote WTRU may receive (e.g., be configured with) conditions for whether to perform such reselection based on HO or not (e.g., as described herein).

A remote WTRU in RRC_CONNECTED may determine whether to release a PC5-RRC connection and/or trigger a relay (re) selection. It may be possible that the determination of the release of a PC5-RRC connection and/or trigger a relay (re) selection, for example, may be based on whether the handover (HO) may be performed to the same cell to which the current relay may be connected to. It may be possible that the remote WTRU keeps the PC5-RRC connection, for example, if the HO may be to the same cell. It may be possible that the remote WTRU releases the PC5-RRC connection and/or performs relay reselection and/or initiates reporting of relay measurements, for example, if the HO may be to a different cell.

A remote WTRU in RRC_CONNECTED may determine whether to release a PC5-RRC connection and/or trigger relay (re) selection. For example, this may be based on whether the HO performed to a cell which may be related (e.g., in the same configured group of cells or configured area) and/or whether the cells belong to the same gNB.

A remote WTRU may receive (e.g., in the HO/reconfiguration command) an indication of whether to release the existing PC5-RRC connection, initiate PC5-RRC connection to a new relay (possibly provided within the HO command), initiate measurement/reporting of other relays, or a combination of such. A WTRU may limit (e.g., any) measurements or measurement reporting to relays whose cells are part of the same gNB/group as the cell on the direct Uu link. A WTRU may limit measurements or measurement reporting, for example, to relays whose cell may be the same as the cell on the direct Uu link. A remote WTRU may perform the limiting of the measurements, for example, if indicated in the HO command (e.g., via a flag).

A remote WTRU in RRC_CONNECTED may trigger a relay reselection procedure, for example, based on a HO from one cell to another cell.

The condition(s) for initiating transmission over a relayed (e.g., secondary) path (e.g., indirect path, for example, such as a path using a relay WTRU) may depend on the RRC state information at the relay WTRU, cell ID, and/or QoS.

In examples, a relay WTRU that has a direct Uu link (e.g., direct path) for data transmission/reception may determine the condition(s) for initiating transmission/routing over a secondary (possibly relayed) link based on one or more of the following: an RRC state of the relay WTRU, a cell ID of the relay (e.g., in comparison to a cell served by the remote WTRU), a QoS of the bearer(s) configured at the remote WTRU and/or with data available for transmission; etc.

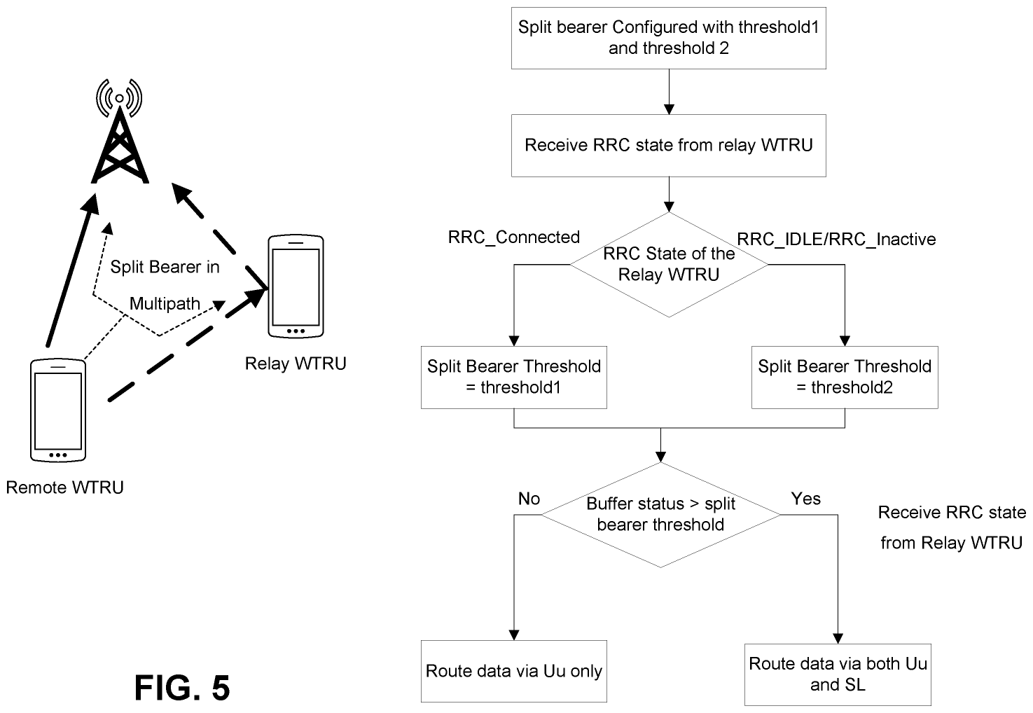

FIG. 5 illustrates an example of determining transmission path(s) using state information.

In examples, a remote WTRU having a direct Uu link for data transmission/reception may determine the condition(s) for initiating transmission/routing over a secondary (possibly relayed) link (e.g., as shown in FIG. 5) based on an RRC state of the relay WTRU (e.g., sending duplicate data via both the direct path and the indirect path, splitting the data between the direct path and the indirect path, or sending the data via the indirect path (e.g., only)). For example as shown in FIG. 5, the remote WTRU may be configured with (e.g., receive configuration information, such as multipath transmission configuration information, indicating) a first condition (e.g., in terms of amount of data available for transmission that may initiate use of the secondary path) if (e.g., when) the relay WTRU may be in RRC connected (e.g., if a determined data volume available for transmission exceeds a first threshold associated with RRC Connected state, as shown in FIG. 5), and with (e.g., receive configuration information, such as multipath transmission configuration information, indicating) a second condition if (e.g., when) the relay WTRU may be in IDLE/INACTIVE (e.g., if a determined data volume available for transmission exceeds a second threshold associated RRC Idle or Inactive state, as shown in FIG. 5). For example, the WTRU may select a split bearer threshold (e.g., condition) based on the indicated state information associated with the relay WTRU (e.g., the split bearer threshold may be determined to be the first threshold/condition associated with the relay WTRU being in RRC Connected state, and the split bearer threshold may be determined to be the second threshold/condition associated with the relay being in RRC Inactive or Idle state, e.g., as shown in FIG. 5). The WTRU may determine that for a relay WTRU indicated to be in RRC Connected state, the data volume exceeds the first threshold associated with the RRC Connected state, and based on the determination that the data volume exceeds the first threshold, the remote WTRU may transmit the data using the indirect path (e.g., via the relay WTRU). The WTRU may determine that for a relay WTRU indicated to be in RRC Idle/Inactive state, the data volume exceeds the second threshold associated with the RRC Idle/Inactive state, and based on the determination that the data volume exceeds the first threshold, the remote WTRU may transmit the data using the indirect path (e.g., via the relay WTRU). The second threshold associated with the RRC Inactive/Idle state may be higher than the first threshold associated with the RRC Connected state (e.g., to avoid switching the SL relay to a Connected state for a short data burst). The remote WTRU may be allowed to route data to the secondary path if (e.g., when) the relay WTRU is in RRC_IDLE/RRC_INACTIVE if (e.g., only if or only when) the data available for transmission may be associated with a specific bearer. A WTRU may be configured with a first bearer or bearer type which may allow routing to the secondary path for an RRC_IDLE/INACTIVE relay, and a second bearer or bearer type for which routing to the secondary path may be performed (e.g., only be performed) if (e.g., when) the relay WTRU may be in RRC_CONNECTED. For example, if the remote WTRU triggers Uu RLF, it may initiate transmission of data via the secondary path (e.g., as long as the relay WTRU is in RRC_CONNECTED). Otherwise, if the relay WTRU is in RRC_IDLE/RRC_INACTIVE, the remote WTRU may trigger a re-establishment or CHO, for example, based on triggering Uu RLF.

In examples, a relay WTRU having a direct Uu link for data transmission/reception may determine the condition(s) for initiating transmission/routing over a secondary (possibly relayed) link based on a cell ID of the relay (e.g., in comparison to a cell served by the remote WTRU). The remote WTRU may be configured with a first condition (e.g., in terms of amount of data available for transmission that may initiate use of the secondary path) if (e.g., when) the relay WTRU is served with the same cell as the remote WTRU, and with a second condition if (e.g., when) the relay WTRU is served by a different cell than the remote WTRU. The remote WTRU may route data (e.g., may be allowed to route data) to the secondary path if (e.g., when) the relay WTRU may be served by the same cell ID as the remote WTRU, for example, if (e.g., only if or only when) the data available for transmission may be associated with a bearer (e.g., specific bearer). A WTRU may be configured with a first bearer or bearer type that may allow routing to the secondary path for the same/different cell scenario, and a second bearer or bearer type for which routing to the secondary path may be limited (e.g., not allowed). If the remote WTRU triggers Uu RLF, it may initiate transmission of data (e.g., via the secondary path) if (e.g., as long as) the relay WTRU is served by the same cell as the remote WTRU. Otherwise, if the relay WTRU may be served by a different cell, the remote WTRU may trigger a re-establishment or CHO based on triggering Uu RLF. The remote WTRU may be configured with a set of cell IDs for which data transmission may be allowed on a bearer to either path.

In examples, a relay WTRU having a direct Uu link for data transmission/reception may determine one or more conditions for initiating transmission/routing over a secondary (possibly relayed) link based on a QoS of the bearer(s) configured at the remote WTRU and/or with data available for transmission. For example, the conditions (e.g., as described herein) may depend on the bearer, on the QoS of the flows mapped to the bearer, on the configuration of the bearer (e.g., split vs non-split bearer), or on any (e.g., specific) configuration element associated with the bearer.

A WTRU may initiate a Uu RRC message/procedure or another procedure via the relay (e.g., prior to data transmission).

A remote WTRU may have a PC5-RRC connection with a relay WTRU while performing active data transmission over Uu. A remote WTRU may be configured with conditions to initiate transmission/reception of data for a Uu RRC connection, for example, via the relay WTRU. Such conditions may be a condition (e.g., any of the conditions), for example, as described herein (e.g., conditions for performing relay (re) selection). Such conditions may apply to determining whether to transmit data via the indirect link. Such conditions may be applicable to determining whether an RRC message may be used (e.g., required) to transmit data via the indirect link. Such conditions may be applicable to determining (e.g., during a reconfiguration that may add an indirect link) whether to transmit the complete message via the indirect link or the direct link. Such conditions may apply to determining whether (e.g., prior to transmission of data via the indirect link) the WTRU (e.g., first) transmits an RRC message. The remote WTRU may (e.g., alternatively) initiate transmission/reception following an indication (e.g., explicit indication) by the network. For example, the remote WTRU may receive an RRC message (e.g., RRCReconfiguration) which may initiate or allow transmission/reception via the relayed path of a multipath connection. For example, the remote WTRU may receive signaling (e.g., a MAC CE) enabling such transmission/reception (e.g., by configuring UL PDCP duplication on a split bearer). For example, the remote WTRU may receive an indication (e.g., in an RRC message) about whether to transmit data to the indirect link or to first transmit an RRC message followed by data.

Following such decision/trigger, the remote WTRU may be configured to perform one or more of the following behaviors (e.g., prior to routing data via the relayed path): enable/activate one or more bearers on the SL path or the leg of a split bearer operating on the SL path which may involve enabling PDCP to route data via the SL RLC entity; transmit a Uu RRC message via the relayed path (e.g., where the remote WTRU may be configured to transmit a PC5-RRC message to the relay, where such RRC message (e.g., PC5 or Uu) may be transmitted prior to allowing the remote WTRU to perform UP data transmission to the relay WTRU); perform data transmission (e.g., first via a default bearer or SL RLC data channel), for example, before transmitting subsequent data (e.g., via other relayed bearers or relayed SL RLC channels); wait for successful transmission of an RRC message (e.g., RLC ACK from the relay WTRU), for example, before performing a (e.g., any) data transmission (e.g., UP data transmission) via the relayed path; wait for an indication from the relay WTRU and/or the network (e.g., via the relayed path), for example, before a (e.g., any) data transmission (e.g., UP data transmission) may be performed via the relayed path; wait to receive data (e.g., any data, any DL data) from the relayed path (e.g., associated with the same RRC connection), for example, before it may perform data transmission (e.g., UL data transmission) via the relayed path; wait for a confirmation RRC message in response to its own RRC message transmission, for example, before it may perform data transmission (e.g., UL data transmission) via the relayed path; initiate (e.g., immediately initiate) routing of data to the relayed path, for example, without the need for any additional action; wait for a trigger (e.g., a NW message such as a DCI, MAC CE, etc.) prior to transmission of data (e.g., UP data) via SL (e.g., which may be to ensure that the RRC connection of the relay WTRU was successful, and/or where the remote WTRU may perform such behavior after another behavior (e.g., transmission of an RRC message); send an indication (e.g., explicit/implict indication) to the network that it intends to perform transmission via the SL path (e.g., the WTRU may trigger an UL RRC message to the network); delay transmission of data (e.g., UL UP data) following (e.g., possibly following) sending of an explicit/implicit indication to the network, for a period of time; determine whether to transmit a message (e.g., an RRC message) via the direct or indirect link, or to transmit via both (e.g., duplication); determine whether to transmit a message (e.g., PC5-RRC message), for example, in response to a reconfiguration message (e.g., addition/release) or a Uu RRC message; etc.

Following such decision/trigger, the remote WTRU may perform data transmission (e.g., first via a default bearer or SL RLC data channel), for example, before transmitting subsequent data (e.g., via other relayed bearers or relayed SL RLC channels). The approach may trigger (e.g., enable) an RRC connection at the relay WTRU, for example, in case the relay WTRU may be in RRC_IDLE/RRC_INACTIVE. The remote WTRU and relay WTRU may be indicated (e.g., be configured with) a default SL RLC data channel. At the relay WTRU (e.g., for example, based on reception of a message on the default SL RLC channel and if the relay WTRU may be in RRC_IDLE/RRC_INACTIVE) the relay WTRU may initiate an RRC connection.

Following such decision/trigger, the remote WTRU may be configured to (e.g., prior to routing data via the relayed path) delay transmission of data (e.g., UL UP data) following (e.g., possibly following) sending of an explicit/implicit indication to the network, for a period of time. For example, the remote WTRU may track a time (e.g., start a timer) following transmission of the UL indication. If a duration may be determined to have elapsed based on the tracked time (e.g., the timer expires) without an indication from the network or the WTRU that data cannot be routed (e.g., SL indication or similar error message described herein), the WTRU may initiate routing of the data. The remote WTRU may (e.g., alternatively) track a time (e.g., start a timer) whereby it initiates routing based on reception of a NW or relay WTRU indication, and may trigger a recovery procedure based on determining a duration has elapsed based on the tracked time (e.g., expiry of the timer).

A remote WTRU may perform (e.g., determine whether to perform) one or more operations (e.g., as described herein, such as one or more of the above behaviors) and/or choose which of the operations (e.g., as described herein, such as one or more of the above behaviors) to perform prior to data transmission. For example, this may be based on one or more of the following: an explicit network indication; an implicit network indication; SL configuration information; information provided by the relay WTRU (e.g., the RRC state); the cell ID of the cell serving the relay and/or remote WTRU; a period of time associated with previous sidelink activity (e.g., time since the last sidelink activity); the Qos and/or bearer configuration information at the remote WTRU; etc.

A remote WTRU may perform (e.g., determine whether to perform) one or more operations (e.g., as described herein) and/or which of the operations (e.g., as described herein) to perform prior to data transmission, for example, based on an explicit network indication. For example, the remote WTRU may receive a message (e.g., an RRC message) which may initiate data transmission over a SL relay path. The RRC message may include, for example, a reconfiguration message (e.g., which may add the indirect path to the multipath). The remote WTRU may receive as an indication in the message (e.g., RRC message) indicating whether or not and/or which of the actions (e.g., as described herein) to perform before initiating SL data transmission. For example, the reconfiguration message may contain an (e.g., explicit) indication of whether the RRCReconfigurationComplete message should be sent via the direct path or via the indirect path. The relay WTRU may (e.g., alternatively) receive such configuration information (e.g. in an RRC message similar to a conditional handover configuration) prior to the trigger to initiate UP data transmission via the relay (e.g., in a conditional routing command as described herein). For example, the remote WTRU may determine whether/which of the actions (e.g., as described herein) to perform prior to data routing based on information in the SIB (e.g., an indicator in SIB to perform RRC message transmission prior to any data transmission).

A remote WTRU may perform (e.g., determine whether to perform) one or more operations (e.g., as described herein) and/or which of the operations (e.g., as described herein) to perform prior to data transmission, for example, based on an implicit network indication. For example, the remote WTRU may initiate one of the actions (e.g., as described herein) prior to data transmission based on one or more characteristic of a received network message. For example, the remote WTRU may receive (e.g., in an RRC message from the network) an embedded message (e.g., embedded RRC message) to be transmitted based on triggering data transmission (e.g., UP data transmission) via the SL path. The remote WTRU may perform message transmission (e.g., RRC message transmission) via the relay path before initiating UP data transmission, for example, if the message (e.g., RRC message) contains the embedded message (e.g., embedded RRC message). The remote WTRU may re-use or transmit the received and embedded RRC message via the relayed path.

A remote WTRU may perform (e.g., determine whether to perform) one or more operations (e.g., as described herein) and/or which of the operations (e.g., as described herein) to perform prior to data transmission, for example, based on based on the SL configuration. For example, the remote WTRU may perform (e.g., determine whether to perform) an (e.g., any) action(s) (e.g., as described herein) based on a property associated with the PC5-RRC configuration information. The remote WTRU may transmit the RRC message, for example, if the PC5-RRC connection with the relay WTRU may be configured with SL DRX or it may be configured with SL DRX having a (e.g., specific) property (e.g., SL DRX cycle above a threshold, SL on duration below a threshold, etc.).

A remote WTRU may perform (e.g., determine whether to perform) one or more operations (e.g., as described herein), and/or which of the operations (e.g., as described herein) to perform prior to data transmission, for example, based on based on information provided by the relay WTRU (e.g., the RRC state). The remote WTRU may perform (e.g., determine whether/which to perform) of the action(s) (e.g., as described herein) based on an indication, information, or lack thereof provided by the relay WTRU (e.g., via PC5-RRC, discovery message, adaptation layer control PDU, etc). For example, such determination and/or performance may be based on operations (e.g., as described herein) associated with providing the remote WTRU with information about the relay WTRU's RRC state. The remote WTRU may transmit a Uu RRC message (e.g., ReconfigurationComplete), for example, if (e.g., when) the relay WTRU may be in RRC_CONNECTED. The remote WTRU may transmit a PC5-RRC message (e.g., SidelinkReconfiguration message), for example, if (e.g., when) the relay WTRU may be in RRC_IDLE/RRC_INACTIVE.

A remote WTRU may perform (e.g., determine whether to perform) one or more operations (e.g., as described herein) and/or which of the operations (e.g., as described herein) to perform prior to data transmission, for example, based on the cell ID of the cell serving the relay and/or remote WTRU. The remote WTRU may refrain from transmitting a message (e.g., an RRC message), for example, if the cell ID of the cell serving the relay may be the same as that of the remote WTRU. Otherwise, the remote WTRU may transmit a message (e.g., an RRC message).

A remote WTRU may perform (e.g., determine whether to perform) one or more operations (e.g., as described herein) and/or which of the operations (e.g., as described herein) to perform prior to data transmission, for example, based on a period of time associated with previous sidelink activity (e.g., time since the last sidelink activity). For example, the remote WTRU may be (pre) configured with a period of time since the last transmission of data/control on SL/relayed path for which an (e.g., one) action (e.g., as described herein) may be performed (e.g., required). The remote WTRU may perform message transmission (e.g., RRC message transmission), for example, if the remote WTRU has not transmitted/received anything to/from the relay WTRU (e.g., for at least the (pre) configured period of time. Otherwise, the remote WTRU may initiate (e.g., directly initiate) data routing to the relay WTRU. The transmission/reception considered for determining the time period at the remote WTRU may be one or more of the following: a UL data transmission by the remote WTRU; a UL Uu RRC message transmission by the remote WTRU; a message on PC5 RRC (e.g., PC5-RRC, discovery, adaptation layer control PDU such as flow control, etc.); a relayed DL data transmission by the relay WTRU of UP data; a relayed transmission by the relay WTRU of a Uu RRC message; etc. For example, the remote WTRU may transmit UL data without a message (e.g., RRC message).

A remote WTRU may perform (e.g., determine whether to perform) one or more operations (e.g., as described herein) and/or which of the operations (e.g., as described herein) to perform prior to data transmission, for example, based on the QoS and/or bearer configuration information at the remote WTRU. For example, the remote WTRU may be configured with per-bearer configuration information or a per-bearer indication of whether/which of the action(s) (e.g., as described herein) may be performed (e.g., required). Such an approach may be taken in the case where the network may prefer to page the relay WTRU which may be in RRC_IDLE/RRC_INACTIVE (e.g., rather than relay on the remote WTRU transmitting the RRC message). For example, the remote WTRU may determine whether RRC message transmission may be performed (e.g., required) based on the per-bearer configuration information and/or data buffer status at the remote WTRU associated with each bearers. The remote WTRU may determine to transmit (e.g., the need to transmit) a message (e.g., an RRC message) or not based on one or more of the following: none or at least one of the bearers are configured with the need for transmission of an RRC message; none or at least one of the bearers are configured as not needing transmission of an RRC message; none or at least one of the bearers are configured with a priority above/below a threshold; none or at least one of the bearers are configured as a split bearer and/or a bearer that may be configured a (e.g., only) with the relayed path; based on the amount of data available for transmission at the WTRU (e.g., potentially at one of the bearers configured as described herein). A remote WTRU may transmit a message (e.g., an RRC message), for example, if none of the bearers configured to allow transmission via the relayed path have a priority above/below a threshold. A remote WTRU may transmit an RRC message, for example, if the bearer which triggered transmission via the relayed path has a priority above/below a threshold.

The remote WTRU may determine which path to transmit an RRC message (e.g., an RRCReconfigurationComplete), for example, based on the configuration of SRB. The WTRU may transmit a (e.g., complete) message via the indirect path (e.g., whenever the complete message results from adding an indirect path), for example, if the WTRU is configured with split SRB. The WTRU may (e.g., alternatively) transmit a (e.g., complete) message (e.g., via the direct path), for example, if the WTRU is configured with non-split SRB (e.g., SRB via direct only).

The remote WTRU may determine whether to send a Uu RRC message or a PC5 RRC message in response to a Uu reconfiguration (e.g. to add a path), for example, based on whether the remote WTRU's SRB is configured as split SRB or not. The remote WTRU may send an indication (e.g., in a PC5-RRC message or an RRC reconfiguration message) on sidelink to the relay WTRU, for example, if the remote WTRU is configured with SRB transmission via direct path (e.g., only), and the remote WTRU receives a reconfiguration message adding the indirect path. In such case, the remote WTRU may further transmit a Uu RRC message following the PC5-RRC message/unicast link establishment (e.g., transmit such message via the direct link only). The remote WTRU may (e.g., alternatively) transmit (e.g., only) a Uu RRC message (e.g., complete message), for example, if the remote WTRU's SRB may be configured as split (e.g., SRB transmission may be allowed via the indirect path).

The PC5-RRC message may trigger the relay WTRU to become connected. Whether the remote WTRU decides to use a PC5-RRC message to force the relay WTRU to CONNECTED or not may depend on the decision of where the remote WTRU sends (e.g., will send) the complete message. The remote WTRU may receive (e.g., be configured with) rules (e.g., as described herein) to determine where to send the complete message (e.g., send to primary path only when no split is configured, send to either path based on other conditions when split is configured). The remote WTRU may trigger a corresponding PC5-RRC message (e.g., based on this decision), for example, if the remote WTRU decides to send the complete message to the direct path.

The procedures as described herein may apply to the case where the remote WTRU wishes to transmit data via the indirect path and determines that a trigger to the relay to initiate a connection may be to be used (e.g., needed), for example, based on mechanisms described herein (e.g., such as a lack of UL/DL data transmission from the relay, indication of the RRC state of the relay UE, etc.). The remote WTRU (e.g., if it determines to send data via the indirect path and such trigger may be needed) may perform transmission of an RRC message (Uu or PC5) prior to the data transmission.

In the case that a remote wireless transmit/receive unit (WTRU) may be configured to transmit a radio resource control (RRC) message via the relayed path prior to routing any data, a remote WTRU may determine the protocol of the RRC message (e.g., Uu RRC message or PC5-RRC message) and/or the type of RRC message (e.g., the specific Uu RRC message to transmit) based on one or more of the following.

In the case a remote WTRU is may be configured to transmit a radio resource control (RRC) message via the relayed path prior to routing any data, a remote WTRU may determine the protocol of the RRC message (e.g., Uu RRC message or PC5-RRC message) and/or the type of RRC message (e.g., the specific Uu RRC message to transmit) based on the condition which triggered/initiated data transmission on the SL path. For example, the remote WTRU may select a (e.g., specific) RRC message and/or RRC type for the (e.g., each of the) initiation conditions (e.g., as described herein).

In the case a remote WTRU is may be configured to transmit an RRC message via the relayed path prior to routing any data, a remote WTRU may determine the protocol of the RRC message (e.g., Uu RRC message or PC5-RRC message) and/or the type of RRC message (e.g., the specific Uu RRC message to transmit) based on the QoS and/or bearer configuration information at the remote WTRU. The remote WTRU may select a (e.g., one) RRC message or message type, for example, if (e.g., when) the priority of the bearer/data may be above/below a threshold. Otherwise, the remote WTRU may select another RRC message or message type. The message or message type may be determined by a configuration parameter of the bearer, for example, for which data is available for transmission via SL.

In the case that a remote WTRU may be configured to transmit an RRC message via the relayed path prior to routing any data, a remote WTRU may determine the protocol of the RRC message (e.g., Uu RRC message or PC5-RRC message) and/or the type of RRC message (e.g., the specific Uu RRC message to transmit) based on the cell ID of the cell serving the relay and/or remote WTRU. The relay may transmit a first RRC message, for example, if the cell ID of the cell serving the relay is the same as the cell serving the remote WTRU. The remote WTRU may transmit a second RRC message, for example, if the cell ID of the cell serving the relay may be different from the cell serving the remote WTRU.

In the case that a remote WTRU may be configured to transmit an RRC message via the relayed path prior to routing any data, a remote WTRU may determine the protocol of the RRC message (e.g., Uu RRC message or PC5-RRC message) and/or the type of RRC message (e.g., the specific Uu RRC message to transmit) based on whether transmission/reception by the remote WTRU prior to initiation of data transmission on the SL path was directly on Uu or via a SL relay.

In the case that a remote WTRU may be configured to transmit an RRC message via a relayed path prior to routing any data, a remote WTRU may determine the protocol of the RRC message (e.g., Uu RRC message or PC5-RRC message) and/or the type of RRC message (e.g., the specific Uu RRC message to transmit) based on the number of hops on the SL path of the previous and/or new SL transmission.

In examples, if the WTRU transmits (e.g., determines to transmit) an RRC message based on one of the triggers to initiate SL transmission, the remote WTRU may select the message based on one or more of the following rules.

In examples, if the WTRU transmits (e.g., determines to transmit) an RRC message based on one of the triggers to initiate SL transmission, the remote WTRU may select the message based on if the relay cell may be the same as the remote WTRU's cell on Uu. If the relay cell may be the same as the remote WTRU's cell on Uu and the Uu RSRP is below a threshold, the WTRU may transmit a dummy RRC message or transmit a measurement report if (e.g., when) the relay WTRU is in IDLE/INACTIVE and may refrain from transmitting (e.g., does not transmit) a (e.g., any) RRC message if (e.g., when) the relay WTRU is in CONNECTED. If the relay cell may be the same as the remote WTRU's cell on Uu and there is Uu RLF, the WTRU may transmit UESidelinkInformation or UEAssistanceInformation if (e.g., when) the relay WTRU may be IDLE/INACTIVE and may transmit UESidelinkInformation or UEAssistanceInformation if/when the relay WTRU s CONNECTED.

In examples, if the WTRU transmits (e.g., determines to transmit) an RRC message based on one of the triggers to initiate SL transmission, the remote WTRU may select the message based on if the relay cell is different than the remote WTRU's cell on Uu. If the relay cell is different than the remote WTRU's cell on Uu and a Uu RSRP below threshold, the WTRU may transmit RRCComplete if (e.g., when) the relay WTRU is IDLE/INACTIVE and may transmit RRCComplete if (e.g., when) the relay WTRU is CONNECTED. If the relay cell is different than the remote WTRU's cell on Uu and there is Uu RLF, the WTRU may transmit MCGFailure if (e.g., when) the relay WTRU is IDLE/INACTIVE and may transmit MCGFailure if/when the relay WTRU is CONNECTED.

In examples, if the WTRU transmits (e.g., determines to transmit) an RRC message based on one of the triggers to initiate SL transmission, the remote WTRU may select the message based on if the WTRU is configured by the NW in RRC Connected, and if so the WTRU may use RRM measurements (e.g., use existing RRM measurements). RRC reconfiguration may add a relay (e.g., which may trigger PC5-RRC connection if needed). RRC reconfiguration may trigger a RACH to the serving cell (e.g., if/when the WTRU moves in coverage on Uu).

In examples, if the WTRU transmits (e.g., determines to transmit) an RRC message based on one of the triggers to initiate SL transmission, the remote WTRU may select the message based on whether the WTRU may trigger (e.g., autonomously trigger) a PC5-RRC connection to speed up the process (e.g., data triggers, reliability triggers on Uu, etc.) while in RRC_CONNECTED.

In examples, if the WTRU transmits (e.g., determines to transmit) an RRC message based on one of the triggers to initiate SL transmission, the remote WTRU may select the message based on whether an RRC message may be used to inform the network that the second path is being set up. For example, if an RRC message may be used to inform the network that the second path may be being set up, the WTRU may allow the IDLE/INACTIVE relay to connect. Conditions for setting up this second path may be data triggered, etc. Data triggered (re) selection may be enabled. Setting up the second path may be followed by a transmission of a complete message, or an RRC exchange to get the configuration information (e.g., WTRU may already have the configuration information). The configuration information may be obtained directly from Uu, for example, so the WTRU may transmit a message to the NW via the relayed path or via the Uu path (e.g., Uu path may be legacy). The WTRU may decide which path to send the RRC message or which RRC message to send, for example, based on the state indication from the relay WTRU.

Conditional reselection may be performed (e.g., as described herein). Conditional initiation of an RRC procedure via a relayed path may be enabled and/or performed.

UL transmission may be delayed/suspended by the remote WTRU, for example, to ensure the relay WTRU's connection establishment was successful.

In examples, the remote WTRU may suspend the indirect path of any bearer for a period of time, for example, following initiation of the indirect path by the remote WTRU by one or more of (e.g., any of) the triggering mechanisms as described herein (e.g., transmission of a PC5-RRC message) . . . . The remote WTRU may track a time (e.g., start a timer) and maintain the indirect path of (e.g., any) bearer(s) suspended (e.g., while the time is being tracked, while the timer is running), for example, following transmission of the PC5-RRC message. The path may be enabled, for example, if (e.g., when) a duration of time elapses (e.g., the timer expires). The remote WTRU may release the indirect path, suspend the indirect path, inform the network (via the direct path) or any combination thereof, for example, if the remote WTRU receives a message from the relay WTRU (e.g., prior to the duration of time elapsing, prior to the expiry of the timer (e.g., RRC connection failure indication).

A relay WTRU may determine a (e.g., an appropriate) trigger for initiating an RRC connection, for example, based on whether multipath is configured and corresponding remote WTRU and network signaling.

A relay WTRU may determine whether to initiate a Uu RRC connection based on the establishment/configuration of a PC5-RRC connection (e.g., unicast link), for example, based on an indication by the remote WTRU. The remote WTRU may include in the sidelink reconfiguration message (e.g., PC5-RRC message) a flag and/or configuration information associated with (e.g., specific to) multipath, for example, to indicate that the relay WTRU may (e.g., should) trigger a connection (e.g., PC5-RRC connection). The relay WTRU may initiate an RRC connection (e.g., based on a reception of such flag or of the multipath configuration information from the remote WTRU), for example, if the relay WTRU may be in RRC_IDLE/RRC_INACTIVE.

The remote WTRU may determine whether to set such a flag, for example, depending on the applicability (e.g., need) of the relayed path for the purposes of multipath. The remote WTRU may include such a flag (e.g. multipath flag) in the message (e.g., PC5 RRC reconfiguration message) to the relay WTRU, for example, if the remote WTRU has an active direct path and may be configured by the network to add/change the indirect path. The remote WTRU may refrain from transmitting (e.g., not transmit) the flag, for example, if the remote WTRU may be refraining from adding (e.g., not adding) the indirect path for multipath. In examples, the remote WTRU may receive multipath configuration information to be forwarded to the relay WTRU from the network. The remote WTRU may include the received multipath configuration information in the message (e.g., PC5-RRC reconfiguration message) to the relay WTRU, for example, if the remote WTRU receives such configuration information.

A relay WTRU may be configured with (e.g., different) discovery message transmissions (e.g., L2 ID associated with the discovery), which may be associated with multipath relaying versus other types of relaying. The relay WTRU may initiate an RRC Connection based on establishment of the unicast link, for example, if the relay WTRU is requested to initiate a unicast link from the L2 ID associated with multipath.

A relay WTRU may receive information from the network related to the appropriate trigger for initiating an RRC connection. This information may be present in an SIB or may be received in dedicated signaling and maintained while the relay WTRU may be in RRC_INACTIVE. This information may be used to determine if (e.g., when/whether/how) the relay WTRU initiates a connection (e.g., an RRC connection) for the purposes of multipath, for example, based on triggers (e.g., triggers as described herein) if (e.g., when) the relay WTRU may be in RRC_IDLE/RRC_INACTIVE. For example the relay WTRU may receive a list of remote WTRU identities from the network. The relay WTRU may trigger an RRC connection (e.g., if the relay WTRU may be in RRC_IDLE/RRC_INACTIVE), for example, based on initiating a unicast link with such remote WTRU in the list. The relay WTRU may receive a flag/indication that a (e.g., any) PC5-RRC connection initiated by a remote WTRU (e.g., in response to a specific discovery) may (e.g., should) trigger a Uu RRC connection.

The WTRU may decide over which path to transmit an UL RRC message.

A WTRU may determine the path over which to transmit an UL RRC message in a multipath scenario, for example, based on one or more of the following factors (e.g., rules) or combination of the following factors (e.g., rules). An (e.g., one) approach may be to determine the path based on a factor or combination of factors. An approach (e.g., a different approach, another approach) may be to use a first rule (e.g., checking a first condition) if (e.g., when) a third condition is met, and use a second rule (e.g., checking a second condition) if (e.g., when) the third condition is not met. For example, the factor(s) (e.g., rules) may be associated with one or more of the following: the SRB configuration, whether the path may be a direct path or an indirect path; whether the same or different cell may be configured on the direct and indirect path; whether the link to the relay may be a 3GPP link or a non-3GPP link; whether the RRC message may be a response to a DL RRC message; the type of UL RRC message; the type of DL RRC message to which the UL RRC message may be responding; the operation performed by the DL RRC message to which the UL RRC message may be responding; whether the UL path determined based on another rule corresponds to the direct path or the indirect path; measurements of the direct path, indirect path, sidelink pool conditions (e.g., CBR), and/or the like; the measurement event that triggered a measurement report; an indication from the network; based on the nature of the configuration message to which the remote WTRU may respond with a reconfiguration complete message; based on a path being added/modified, for example, if the reconfiguration includes a path addition/modification; based on the configuration of data bearers; etc.

A WTRU) may determine the path over which to transmit an UL RRC message in a multipath scenario, for example, based on the SRB configuration. The remote WTRU may perform transmission of the RRC message to either path (e.g., based on other conditions) or both paths (e.g., if duplication is configured on SRB), for example, if the remote WTRU is configured with a split SRB (e.g., SRB transmission/reception on either path). The remote WTRU may (e.g., otherwise) transmit the RRC message to the path in which SRB is configured.

A WTRU may determine the path over which to transmit an UL RRC message in a multipath scenario, for example, based on whether the path may be a direct path or an indirect path. UL RRC messages may indicate that the transmission may be to either the direct or indirect path (e.g., require transmission to either the direct or indirect path), for example, if the WTRU is configured with a split SRB. This may be combined with one or more of the following other factors: a message (e.g., specific RRC message) or message type (e.g., measurements) should be sent via the direct path (e.g., only); a (e.g., specific) measurement event may be configured so that if (e.g., when) the event may be triggered, the corresponding measurement report may be sent (e.g., only) on the direct path; etc.

A WTRU may determine the path over which to transmit an UL RRC message in a multipath scenario, for example, based on whether the same or a different cell may be configured on the direct and indirect path. A remote WTRU may send the RRC message via either path (e.g., based on other conditions as described herein), for example, if the remote WTRU is configured via multipath with the same cell on both paths. The remote WTRU may (e.g., otherwise) send the RRC message over the primary path (e.g., the path associated with the PCell, or considered as the anchor). The remote WTRU may use a first rule for determining the path for an RRC message, for example, if (e.g., when) a different cell may be configured on the direct path and indirect path (e.g., always transmit RRC message to the direct path only, unless duplication is configured). The remote WTRU may use a second rule for determining the path for an RRC message, for example, if (e.g., when) the same cell may be configured on the direct path and indirect path (e.g., transmit to the path determined based on UU and/or SL quality). The remote WTRU may determine the path to send a message (e.g., reconfiguration complete message), for example, (e.g., for the case of a path addition/change/removal) based on the cell ID of the direct and/or indirect path (e.g., whether the cell IDs are the same on both paths). The remote WTRU may send the message (e.g., reconfiguration complete message) to the direct path, for example, if the reconfiguration message is adding/changing the direct path and the cell ID of the direct path is different from the cell ID of the indirect path. Otherwise (e.g., if the cells are the same), the remote WTRU may send it to either path.

A WTRU may determine the path over which to transmit an UL RRC message in a multipath scenario, for example, based on the link to the relay, for example, whether the link to the relay may be a first type of link (e.g., a 3GPP link, which may be, for example, a PC5-RRC link) or a second type of link (e.g. a non-3GPP link, which may be, for example, a wired or proprietary link). If the link may be a first type of link (e.g., PC5-RRC), the remote WTRU may transmit the message via the direct link. If the link may be a second type of link (e.g., wired or proprietary link), the remote WTRU may transmit the message via the primary path.

A WTRU may determine the path over which to transmit an UL RRC message in a multipath scenario, for example, based on whether the RRC message is a response to a DL RRC message. For example, the remote WTRU may transmit a response message over the same link as the DL RRC message. The remote WTRU may transmit other RRC messages (e.g. measurement reports) via any of the two links.

A WTRU may determine the path over which to transmit a UL RRC message in a multipath scenario, for example, based on the type of UL RRC message. The remote WTRU may transmit UL RRC messages of a (e.g., specific) type to a predefined path or to a path associated with the primary path. Measurement reports (e.g., all measurement reports) may be transmitted via the primary path. UEAssistanceInformation may be transmitted via the direct link. For example, this may be apply to duplication. For example, a remote WTRU may (e.g., be configured to) send (e.g., always send) a (e.g., specific) RRC message (e.g., complete message) using PDCP duplication.

A WTRU may determine the path over which to transmit an UL RRC message in a multipath scenario, for example, based on the type of DL RRC message to which the UL RRC message may be a response.

A WTRU may determine the path over which to transmit an UL RRC message in a multipath scenario, for example, based on the operation performed by the DL RRC message to which the UL RRC message is responding. The confirmation of a release may be sent to the link opposite of the link that may be being released. The confirmation of an addition may be sent to the link that may be being added. Such a rule may be followed, for example, regardless of the path from which the addition/release was received.

A WTRU may determine the path over which to transmit an UL RRC message in a multipath scenario, for example, based on whether the UL path determined based on another rule corresponds to the direct path or the indirect path. A complete message in response to a path addition may be sent via a path, for example, that depends on the (e.g., specific) path being added and whether that path is direct or indirect. The remote WTRU may send a complete message, for example, for a reconfiguration which adds a path to multipath. The remote WTRU may send a complete message, for example, via the path being added (e.g., if/when the path being added is the indirect path). The remote WTRU may second a complete message, for example, via either a direct or indirect path (e.g., if/when the path being added is the direct path).

A WTRU may determine the path over which to transmit an UL RRC message in a multipath scenario, for example, based on measurements of the direct path, indirect path, sidelink pool conditions (e.g. CBR) or similar. The remote WTRU may send the message via the direct path, for example, if the Uu RSRP of the direct path is above a threshold. The remote WTRU may send the message via the indirect path, for example, if the SL RSRP of the indirect path may be above a threshold. The remote WTRU may send the message on the non-primary path, for example, if the RSRP of the non-primary path may be above a threshold. The remote WTRU may be configured with or may indicate a Uu threshold above which RRC messages are to be sent via the direct path. For example, the remote WTRU may indicate or may be configured with a CBR threshold above which RRC messages are to be sent via the direct path.

A WTRU may determine the path over which to transmit a UL RRC message in a multipath scenario, for example, based on the measurement event that triggered a measurement report. A remote WTRU may be indicated (e.g., in the measurement event configuration information) a specific path (e.g., direct/indirect, primary/non-primary) on which to send the corresponding measurement report if (e.g., when) the event in question may be triggered. The remote WTRU configured with a split SRB may (e.g., then) transmit the RRC measurement report on the path configured in the event which triggered the report. A remote WTRU may be indicated (e.g., configured with) rules (e.g., specific rules) associated with the path to be used, for example, based on what is being measured. For example, the remote WTRU may send the corresponding measurement report via the direct path if the measurement may be triggered as a result of a relay WTRU measurement.

A WTRU may determine the path over which to transmit a UL RRC message in a multipath scenario, for example, based on an indication from the network. For example, the remote WTRU may receive a reconfiguration message with an indication of which path to use to send the reconfiguration complete message. The remote WTRU in multipath may receive a reconfiguration via (e.g., any of) the direct or indirect path. The reconfiguration may indicate the path over which to send the reconfiguration complete message.

A WTRU may determine the path over which to transmit an UL RRC message in a multipath scenario, for example, based on the nature of the reconfiguration message to which the remote WTRU may respond with a reconfiguration complete (e.g., possibly assuming SRB1 may be configured on both paths). The remote WTRU may be configured with certain rules/conditions of which path to send the reconfiguration complete message to, for example, based on the path being configured and potentially other conditions herein (e.g., the RRC state of the relay WTRU). The remote WTRU may send the reconfiguration complete message via the relay path (e.g., as long as the relay path may be configured with SRB1), for example, if the remote WTRU receives a reconfiguration message that adds/changes/reconfigures the relay path. Otherwise (e.g., for a reconfiguration that changes the direct path), the remote WTRU may send complete message to either path. The remote WTRU may send the reconfiguration complete message via the direct path, for example, if the remote WTRU receives a reconfiguration message that changes/reconfigures the direct path. The remote WTRU may send the reconfiguration complete message via the relay path, for example, if the remote WTRU receives a reconfiguration message that adds/changes the relay path and the subsequent (e.g., new) relay is detected to be in RRC_IDLE/RRC_INACTIVE. The remote WTRU may send the reconfiguration complete message via the relay path, for example, if the WTRU receives a reconfiguration message that changes the relay path (e.g., otherwise, it may send it via either path).

A WTRU may determine the path over which to transmit an UL RRC message in a multipath scenario, for example, based on the path being added/modified (e.g., if/when the reconfiguration consists of a path addition/modification). The complete message may be sent to the direct/indirect path, for example, if (e.g., when) the direct/indirect path may be added.

A WTRU may determine the path over which to transmit a UL RRC message in a multipath scenario, for example, based on the configuration of data bearers. The remote WTRU may receive a reconfiguration message adding a path (e.g., the indirect path) and may send the complete message to the indirect path, for example, if the WTRU is configured with at least one bearer on the indirect path.

The WTRU may autonomously change the primary path, for example, based on a condition or based on triggers (e.g., pre-defined triggers).

As used herein, the term primary path may refer to the direct path, or it may refer to the path where the RRC anchor exists, the path corresponding to the PCell, the path where the RRC connection was initially established, or the path where UL RRC messages are transmitted.

A WTRU may autonomously decide/trigger a change of the primary path, for example, based on predefined or preconfigured conditions. A WTRU may operate under the assumption that a non-duplicate split SRB follows the rules for UL transmission similar to dual connectivity (e.g., for non-duplicate SRB, the WTRU transmits RRC messages to the primary path (e.g., only to the primary path only). The WTRU may indicate or may be configured with (e.g., (pre) configured) conditions whereby it may change the primary path, for example, without reception of signaling (e.g., explicit RRC signaling). The WTRU may inform the network explicitly (e.g., by transmitting an RRC message) or implicitly (e.g., by performing the next transmission of RRC via the new path), for example, if (e.g., once) the WTRU has determined to change the primary path. Subsequent (e.g., all subsequent) transmissions (e.g., RRC transmissions) may be performed to the updated (e.g., new) primary path (e.g., until explicitly configured or until a different (e.g., new) trigger changes the path again), for example, if (e.g., once) the WTRU has determined to change the primary path. A WTRU may (e.g., further) be indicated (e.g., configured) to allow primary path changes/decisions (e.g., for certain cases). For example, a WTRU may be indicated by the network to allow primary path changes/decisions. For example, the remote WTRU may (e.g., only) perform the autonomous selection/change of the primary path if (e.g., when) the cell of the direct and indirect paths is the same. The WTRU may be indicated to allow primary path changes/decisions based on the nature of the indirect link between the relay and remote WTRU (e.g., PC5 or non-3GPP link). For example, the remote WTRU may (e.g., only) perform the autonomous selection/change of the primary path if (e.g., when) the indirect link between the relay and remote WTRU is a non-3GPP link).

Conditions for changing the primary path may be the same conditions that determine the UL path for RRC signaling (e.g., as described herein).

In examples, the WTRU may be indicate and/or may be configured with triggers for changing the primary path related to Uu quality and/or SL quality. The WTRU may change the primary path to the indirect/direct path if, for example, if the primary path is via a direct/indirect path and the Uu/SL RSRP measured by the remote WTRU falls below a threshold for a period of time.

In examples, the WTRU may be indicated (e.g., configured with) triggers for changing the primary path related to sidelink resource pool measurements. The WTRU may change the primary path to the direct path, for example, if the primary path is indirect and the CBR is above a threshold.

The remote WTRU may trigger a primary path change following reception of a notification message from the relay WTRU (e.g., associated with mobility of the relay WTRU), for example, depending on the cell configured at the remote WTRU as the PCell. For example, the remote WTRU may change the primary path following reception of a HO indication received by the relay WTRU. The remote WTRU may change the primary path to the direct path based on an HO indication received from the relay WTRU or based on detection of a cell change at the relay WTRU using reception of SIB (e.g., whereby the HO may cause the relay WTRU's cell to be different than the remote WTRU's cell on the direct link), for example, if the remote WTRU has the indirect path as the primary path and the same cell on both the direct and indirect path. Such technique may allow the remote WTRU to maintain the primary path to be associated with the remote WTRU's PCell (e.g., without changing (e.g., the need to change) the PCell following the relay WTRU's mobility.

The remote WTRU may trigger a primary path change following triggering of a measurement event and/or report. For example, the remote WTRU may be indicated (e.g., configured with) a measurement event associated with a change in the primary path (e.g., the indirect path quality falls below a threshold). The remote WTRU may change the primary path and send the corresponding measurement report to the changed (e.g., new) primary path (e.g., at the same time), for example, based on the triggering of the measurement event.

The WTRU may, autonomously (e.g. based on a condition) change the Pcell while in multipath.

In examples (e.g., based on similar conditions as described herein), a remote WTRU may change the PCell associated with multipath from the current PCell (e.g., associated with the direct/indirect link) to a different (e.g., new) PCell (e.g., associated with the other link). Similar conditions/triggers may be used to determine (e.g., at the WTRU) if (e.g., when) such a PCell change may be performed. The remote WTRU may send an RRC message (e.g., ReconfigurationComplete) to indicate (e.g., successful) change of the PCell, for example, following such a PCell change. The remote WTRU may receive a HO indication from the relay WTRU (e.g., changing the relay WTRU's PCell to the same cell as the cell on the remote WTRU's direct link). The remote WTRU may change the PCell to the cell associated with the direct link (e.g., based on such indication), for example, if the remote WTRU's PCell was the cell associated with the indirect link.

The WTRU may (e.g., be configured to) report relays that are connected to one or more cells to the network.

A remote WTRU may (e.g., be configured to) report measurements of relays to the network (e.g., in RRC_CONNECTED). A remote WTRU may (e.g., be configured to) limit the (e.g., specific) relay WTRUs being reported to the network, for example, based on cell to which the reported relay may be connected. A remote WTRU may report relay WTRU(s) (e.g., only the relay WTRU) that meet one or more of the following conditions: are connected to the same cell/PLMN as the remote WTRU's current serving cell; are connected to any cell/PLMN within a list of cells/PLMNs provided to the remote WTRU (e.g., in dedicated signaling or an SIB); are connected to a (e.g., any) cell that may be part of the same area of cell group as the remote WTRU's current serving cell; are connected to a (e.g., any) cell/PLMN that have an inherent/configured relation with the cell to which the remote WTRU may be currently connected (e.g., may be part of the same gNB, may be part of the same DU/CU); etc.

The WTRU may initiate a failure procedure to the network, for example, based on determining that a message (e.g., ReconfigurationComplete message) was not sent successfully.

A remote WTRU may initiate a failure procedure following transmission of a message (e.g., ReconfigurationComplete message), for example, if the remote WTRU determines that the transmission of the message (e.g., reconfigurationComplete message) did not succeed. A remote WTRU may initiate transmission of a message (e.g., reconfigurationComplete message) via the indirect path, for example, following reception of a Uu reconfiguration message (e.g., via the direct path) which adds the indirect path. The remote WTRU may (e.g., decide to) transmit the message (e.g., reconfigurationComplete message) via the indirect path based on conditions (e.g., as described herein).

A WTRU may determine that transmission of the message (e.g., reconfigurationComplete message) was unsuccessful, for example, based on one or more of the following (e.g., occurring within a time period after transmission of the ReconfigurationComplete): absence of the RLC ACK received from the relay WTRU, for example, after a number of retries (e.g., the remote WTRU may determine failure to transmit the reconfigurationComplete message following the number of retransmissions at RLC being reached); reception of a notification message from the relay WTRU with a (e.g., specific cause) value (e.g., failure of the relay WTRU to establish an RRC connection, mobility at the relay WTRU, etc.); determination of a change of the serving cell of the relay WTRU or of the serving gNB of the relay WTRU; failure to receive a message (e.g., RRC message) and/or data from the path that was added as a result of sending the message (e.g., reconfigurationComplete message), for example, after a period of time following transmission of the message (e.g., reconfigurationComplete message); etc.

A WTRU may determine that transmission of a message (e.g., reconfigurationComplete message) was unsuccessful, for example, based on a reception of a notification message from the relay WTRU with a (e.g., specific cause) value (e.g., failure of the relay WTRU to establish an RRC connection, mobility at the relay WTRU, etc.). For example, the remote WTRU may determine failure to transmit the reconfigurationComplete message following reception of a sidelink notification message (e.g., within a period of time) with a cause value of relay connection failure. For example, the remote WTRU may determine failure to transmit the message (e.g., reconfigurationComplete message) following reception of a sidelink notification message (e.g., within a period of time) with a cause value of relay WTRU HO. For example, the remote WTRU may determine failure to transmit the message (e.g., reconfigurationComplete message) following reception of a sidelink notification message (e.g., within a period of time) with a cause value of relay WTRU reselection.

A WTRU may determine that transmission of the message (e.g., reconfigurationComplete message) was unsuccessful, for example, based on a determination of a change of the serving cell of the relay WTRU or the serving gNB of the relay WTRU. The remote WTRU may determine failure to transmit the reconfiguration message, for example, if the relay WTRU receives a HO from the relay WTRU, reselection by a relay WTRU, to a different cell, or to a cell associated with a different gNB. Whether the HO/reselection is to a different or same gNB may be used to determine whether a failure may be determined. The behavior as a result of the failure may be determined (e.g., as described herein).

A WTRU may determine that transmission of the message (e.g., reconfigurationComplete message) was unsuccessful, for example, based on a failure to receive an RRC message and/or data from the path that was added as a result of sending the reconfigurationComplete message (e.g., after a period of time following transmission of the reconfigurationComplete message). The remote WTRU may determine failure to transmit the message (e.g., reconfigurationComplete message), for example, if the WTRU does not receive a (e.g., any) message (e.g., data and/or control message) from the path which was added within a period of X after transmission of the complete message. During that period, the remote WTRU may (e.g., further) suspend (e.g., only) the UL transmissions to that path, and may resume UL transmission to the path, for example, if a DL message is received from the path before a time elapses (e.g., expiry of the timer). For example, such failure may be applicable regardless of the path to which the message (e.g., reconfigurationComplete message) may be being transmitted. For example, the period of time after which a failure may be declared (e.g., via the timer) may depend on the path in which the remote WTRU decides to send the message (e.g., a first timer may be used for the direct path and a second timer may be used for the indirect path). For example, the time may be measured starting from reception of the RLC ACK (e.g., SL RLC ACK for transmission over SL, and Uu RLC ACK for transmission over the direct path).

A WTRU (e.g., following determination of the failure of transmission of the reconfigurationComplete message) may initiate a failure procedure/recovery procedure with the network. The type of recovery procedure may (e.g., further) depend on the type/reason for the failure (e.g., the cause value), for example, as described herein. The type of recovery procedure may (e.g., further) depend on the primary path (e.g., whether the primary path and/or the PCell may be considered to be the indirect path or the direct path).

The failure recovery procedures may include one or more of the following: transmission of a message (e.g., ReconfigurationFailure message), for example, via the direct link; transmission of another error message (e.g., RRC error message) other than a reconfiguration failure message, for example, via the direct link, such as an SCGFailure message, or message similar to the SCGFailure message; release of the PC5-RRC connection with the relay WTRU; reverting to the previous (e.g., RRC) configuration prior to reception of the RRCReconfiguration by the remote WTRU (e.g., that generated the reconfiguration complete message); suspending the transmission/reception from the indirect link while keeping transmission/reception via the direct link active; tracking a time (e.g., initiating a timer) and performing an action (e.g., any other of the actions as described herein) based on the time elapsing (e.g., on expiry of the timer) or any other action (e.g., any other of the actions described herein) if another event occurs while time is being tracked (e.g., while the timer may be running); suspending transmission/reception via the indirect link for a period of time, after which transmission/reception may be initiated normally; triggering a re-establishment; etc.

The failure recovery procedures may include transmission of another error message (e.g., RRC error message) other than a reconfiguration failure message, for example, via the direct link, such as an SCGFailure message, or message similar to the SCGFailure message. For example, a SCGFailure-like message may be transmitted and may contain a cause value associated with the cause value received in the notification message, the (e.g., new) cell ID of the relay WTRU (e.g., in the case of HO or reselection by the relay WTRU), an indication that Uu RLF was indicated by the relay WTRU, etc.

In examples, a remote WTRU may perform one or more of the following (e.g., after attempting transmission of a reconfiguration complete message via the indirect path): the remote WTRU may revert to the previous RRC configuration (e.g., prior to transmission of the complete message via the indirect link) and transmit an RRCReconfigurationFailure message via the direct link, for example, if the failure may be caused by a notification from the relay related to a failure to establish an RRC connection at the relay; the remote WTRU may suspend transmission/reception via the indirect path and send an RRC message to the network (e.g. SCGFailure-like message) via the direct link, possibly indicating the (e.g., new) serving cell ID of the relay WTRU, for example, if the failure may be caused by a notification from the relay WTRU indicating a HO by the relay WTRU; the remote WTRU may trigger a re-establishment, for example, if the failure may be caused by a notification of Uu RLF from the relay WTRU; the remote WTRU may track a time (e.g., initiate a timer) and suspend transmission via the indirect path, for example, if the failure may be caused by a notification of reselection by the relay WTRU, and the remote WTRU may initiate normal transmission via the indirect path, for example, if the time elapses (e.g., timer expires) without additional notification or reconfiguration.

The remote WTRU may consider one or more of the actions (e.g., as described herein), for example, based on a failure to be associated with transmission of the ReconfigurationComplete, e.g., as long as the event (e.g., reception of notification from the relay) is received within a period of time following transmission of the ReconfigurationComplete. The WTRU may consider the transmission of the ReconfigurationComplete message successful, for example, following expiry of the time period without such event, and (e.g., any) subsequent handling of messages from the relay may be handled based on procedures as described herein (e.g., procedures associated with handling SL failure/mobility).

SL failure/mobility procedures may be handled.

A WTRU may initiate different procedure(s) in response to receiving a UuMessageTransferSidelink or in response to the WTRU detecting SL-RLF. Herein, the terms UuMessageTransfer and Sidelink notification are used interchangeably. The terms may refer to a message sent by the relay WTRU to the remote WTRU.

The WTRU may perform one or more of the following procedure(s) (e.g., the different procedure(s) in response to a reception of a message (e.g., UuMessageTransferSidelink). The WTRU may perform one or more of the following procedure(s) based on a detection of SL-RLF (e.g., detected by the remote WTRU). For example, reception of a message (e.g., UuMessageTransferSidelink) may be replaced in the below procedures by detection of SL-RLF, and, without loss of generality, the below procedure(s) may (e.g., still) apply.

Indications (e.g., current indications) from the relay WTRU to the remote WTRU, which may be supported via the UuMessageTransferSidelink, may include one or more of the following: a Uu RLF indication message (e.g., sent by the relay WTRU if/when the relay WTRU experiences Uu RLF); an indication that a HO was performed at the relay WTRU; an indication that a cell reselection was performed at the relay WTRU; or an indication that the relay WTRU failed to perform RRC connection establishment. Indications from the relay WTRU to the remote WTRU may include indications herein, such as an indication of the change of state of the relay WTRU (e.g., from RRC_CONNECTED to RRC_IDLE/RRC_INACTIVE).

A remote WTRU may initiate one or more of the following actions (e.g., following the reception of a UuMessage TransferSidelink from a relay WTRU): initiate a relay and/or cell reselection; release the PC5-RRC connection with the relay WTRU; suspend a bearer (e.g., configured over the relay path), or an RLC entity/leg of a split bearer associated with the relay path; send an RRC message/indication to the network (e.g., where the contents and/or type of message, such as a RRC message type, e.g. RRC message versus BSR transmitted may further depend on the factors as described herein); initiate an RRC connection/resume procedure, for example, if in IDLE/INACTIVE (e.g., with an existing establishment/resume cause, with a new establishment/resume cause, including information related to the reception of the message in the complete message, or where the cause or the information included in the complete message may depend on the message and/or the factors as described herein); re-establish or reset a protocol layer (e.g., re-establish PDCP, reset MAC entity of the SL path or a bearer over the SL path, etc); transmit a PDCP status report or request PDCP status report; apply a conditional reconfiguration (e.g., such as a CHO, CPAC, or conditional bearer reconfiguration); transition to RRC_IDLE (e.g., from RRC_CONNECTED); initiate a re-establishment procedure; perform relay reselection with or without re-establishment; perform (e.g., only) UL data transmission (e.g., either on the Uu or the SL), for example, by performing a RACH procedure, SR procedure, or BSR procedure prior to data transmission; perform re-establishment without reselection of the relay (e.g., relay on the relay to perform cell reselection); change the primary path of a bearer from a first path to a second path; initiate a procedure (e.g., similar to re-establishment) to the cell (e.g., directly to the cell) associated with the direct Uu path; etc.

The remote WTRU may initiate one or a combination of a first action (e.g., following reception of the UuMessageTransferSidelink message), and may initiate one or a combination of a second action (e.g., some period of time after the first action, for example, if a condition is not satisfied before that period of time). The WTRU may possibly perform a third action or combination of actions, for example, if the condition is satisfied. Such conditions may include conditions associated with the factors (e.g., as described herein), which may include: reception of a message (e.g., reconfiguration) from the relay WTRU or the network; successful or failed reselection successful or failed connection establishment by the remote WTRU; successful or failed conditional reconfiguration; reception of another (e.g., different type) of message (e.g., UuMessageTransferSidelink message) from the relay WTRU indicating success or failure of the operation associated with the first message received; etc.

The action or actions (e.g., specific action or actions) performed by the remote WTRU may depend on one or more of the following factors (e.g., conditions). The WTRU may perform (e.g., only perform) an action (e.g., such as the below first action and/or second action), for example, if one or a combination of conditions associated with one or a combination of factors is satisfied. The WTRU may perform a first action, for example, if a first combination of conditions associated with a first combination of factors is satisfied, and may perform a second action, for example, if a second combination of conditions associated with a second combination of factors is satisfied, etc. Such factors (e.g., which may apply to the first and/or second action) may include one or more of the following: the RRC state of the remote WTRU; the RRC state of the relay WTRU; the type of UuMessageTransferSidelink message (e.g., Uu RLF, Ho, etc.); the contents of the Uu message transfer sidelink message; the bearer configuration at the remote WTRU; the QoS of the bearer(s) at the remote WTRU; whether the relay WTRU is served by the same/different cell than the remote WTRU; whether the remote WTRU is configured with a conditional bearer reconfiguration and/or CHO/CPAS or not; whether the remote WTRU is in coverage or out of coverage; whether the remote WTRU has triggered (e.g., already triggered) Uu RLF on a Uu link; whether the remote WTRU has an active path over Uu (e.g., has at least one bearer configured for transmission/reception over Uu if/when in RRC_CONNECTED, or is camped on a cell in Uu if/when IDLE/INACTIVE); whether the remote WTRU is monitoring PDCCH; whether the remote WTRU is operating in mode 1 or mode 2 on sideline; depending on whether cell/relay reselection results in selection of a cell or a relay; whether the remote WTRU is configured with duplication; whether the remote WTRU is configured with a split bearer, or bearers (e.g., only bearers) which allow transmission to only one path at a given time; whether a path is configured as the primary path and which is considered the primary path; etc.

The action or actions (e.g., specific action or actions) performed by the remote WTRU may depend on the RRC state of the remote WTRU. For example, if the remote WTRU is in RRC_IDLE/RRC_INACTIVE it may perform a first action based on reception of a message (e.g., reselection, connection establishment), and if the remote WTRU is in RRC_CONNECTED it may perform a second action.

The action or actions (e.g., specific action or actions) performed by the remote WTRU may depend on the type of UuMessageTransferSidelink message (e.g., Uu RLF, HO, etc.). The action performed by the remote WTRU may depend on the type of UuMessageTransferSidelink received (e.g., Uu RLF, HO, etc.).

The action or actions (e.g., specific action or actions) performed by the remote WTRU may depend on the contents of the Uu message transfer sidelink message. For example, contents of the Uu message transfer sidelink message may include the cell ID of the cell to which the remote WTRU is connected. For example, the remote WTRU's behavior may depend on whether the cell ID indicated in the UuMessageTransferSidelink message is in the same or different RAN area, tracking area as previously or as the cell to which the remote WTRU is camped on Uu.

The action or actions (e.g., specific action or actions) performed by the remote WTRU may depend on the bearer configuration at the remote WTRU. This may include the following: whether the remote WTRU has one or more bearers configured with a leg over the relayed path; whether the remote WTRU has one or more bearers configured a (e.g., only) with a relayed path; and whether the remote WTRU has one or more split bearers configured with duplication.

The action or actions (e.g., specific action or actions) performed by the remote WTRU may depend on the QoS of the bearer(s) at the remote WTRU. The QoS of the bearer(s) at the remote WTRU may refer to an LCH priority configured for the SL or Uu RLC channel. For example, the remote WTRU may have different behaviors based on the reception of the message from the relay depending on whether the remote WTRU may be configured with a bearer having specific priority/QoS or not. The QoS of the bearer(s) at the remote WTRU may refer to the QoS identifier (QI) (e.g., 5G QI) associated with the bearer. The QoS of the bearer(s) at the remote WTRU may refer to whether the bearer may be configured with a property associated with a specific behavior or not (e.g., which may be configured per bearer or per RLC channel).

The action or actions (e.g., specific action or actions) performed by the remote WTRU may depend on whether the relay WTRU may be served by the same or different cell than the remote WTRU. For example, the remote WTRU may perform a procedure based on reception of a message (e.g., only) if (e.g., when) the relay is served by a cell which is different than the remote WTRU.

The action or actions (e.g., specific action or actions) performed by the remote WTRU may depend on whether the remote WTRU is configured with conditional bearer reconfiguration information and/or CHO/CPAC or not. For example, a remote WTRU may be configured with conditional reconfiguration information to be applied based on conditions (e.g., some conditions). The remote WTRU may apply such configuration information based on reception of a message from the relay.

The action or actions (e.g., specific action or actions) performed by the remote WTRU may depend on whether the remote WTRU has triggered (e.g., already triggered) Uu RLF on the Uu link. The remote WTRU may perform a first operation (e.g., transmitting a Uu RRC message) based on reception of a RRC connection failure from a relay WTRU, for example, if there is no pending Uu RLF on Uu, and may perform a second operation (e.g., triggering re-establishment) based on reception of an RRC connection failure from a relay, for example, if there is a pending Uu RLF on Uu. The remote WTRU may release the PC5-RRC connection based on reception of an RRC connection failure, for example, if (e.g., when) the Uu link is not in Uu RLF. The remote WTRU may maintain a PC5-RRC connection and wait for the relay WTRU to perform another connection establishment, for example, if the remote WTRU receives an RRC connection failure from the relay while the Uu link is in Uu RLF.

The action or actions (e.g., specific action or actions) performed by the remote WTRU may depend on whether cell/relay reselection results in selection of a cell or a relay. The remote WTRU may release its bearer configuration, for example, if the remote WTRU selects a cell and was previously connected to a relay (e.g., while it would not release its bearer configuration otherwise).

The action or actions (e.g., specific action or actions) performed by the remote WTRU may depend on whether the remote WTRU is configured with duplication. The remote WTRU may trigger re-establishment, or initiate an RRC message transmission indicating a failure, for example, if the remote WTRU is configured with duplication and the message from the relay WTRU results in the interruption of data transmission via the relay path.

The action or actions (e.g., specific action or actions) performed by the remote WTRU may depend on whether the remote WTRU is configured with a split bearer, or bearers (e.g., only bearers) which allow transmission to a path (e.g., only one path) at a given time. For example, for the case where relay WTRU and the remote WTRU are served by the same cell, the remote WTRU may be configured with a bearer having multiple (e.g., two) separate RLC entities (e.g., one on SL and one on Uu) but may route data (e.g., only be allowed to route data) to one of those RLC entities at a given time. In such a case, if the relay WTRU transmits a Uu RLF indication to the remote WTRU while the remote WTRU is using the relayed path, the remote WTRU may perform UL transmission on the Uu path (e.g., without any additional RRC procedure). If the message is received while the Uu path is in RLF, the remote WTRU may trigger a re-establishment.

The action or actions (e.g., specific action or actions) performed by the remote WTRU may depend on whether a path is configured as the primary path and which is considered the primary path. The remote WTRU may perform a different RRC procedure, for example, if the message is received from the relay, depending on which path is configured as the primary path, or which path is configured to allow transmission/reception of RRC signaling.

In examples, a remote WTRU may inform the network.

A remote WTRU (e.g., in RRC_CONNECTED) may inform the network, for example, based on reception of a UuMessageTransferSidelink. The remote WTRU may send a message (e.g., an RRC message) on Uu based on a reception of the PC5-RRC message on sidelink from the remote WTRU. The remote WTRU may transmit a message (e.g., single message) for (e.g., all) UuMessageTransferSidelink message types, for example, in one option. The remote WTRU may transmit a SidelinkUEInformation message over Uu, for example, including the type of sidelink message (e.g., Uu RLF, CHO, etc). In another option, The remote WTRU may transmit a different RRC message depending on the specific sidelink message received, for example, in an alternative (e.g., another) option. The remote WTRU may transmit an SCGFailureInformation message (e.g., if a Uu RLF is received). The remote WTRU may transmit a SidelinkUEInformation message (e.g., with additional information about the (e.g., new) cell to which the relay has reselected), for example, if the relay indicates it has performed a cell reselection. The remote WTRU may refrain from transmitting (e.g., not transmit) a (e.g., any) RRC message, for example, if the relay indicates it has performed a HO. A remote WTRU may provide (e.g., additional) information to the network regarding the indication received from the relay. The remote WTRU may provide a cell ID (e.g., new cell ID) in the message, for example, for a HO or reselection by the relay WTRU. Whether the message may be transmitted may be conditioned on whether the cell ID changes, or whether the (e.g., new) cell ID for the relay WTRU belongs in a different group compared to the cell ID of the direct path.

In examples, a remote WTRU in RRC_IDLE/RRC_INACTIVE may initiate a connection/resume procedure. A remote WTRU may determine whether the connection/resume procedure is performed, for example, based on the sidelink message and/or its contents. For example, the remote WTRU may initiate an RRC connection (e.g., only), for example, based on reception of a connection establishment failure by the relay WTRU. For example, the remote WTRU may initiate an RRC connection based on reception of a cell reselection by the relay and if the cell (e.g., new cell) is in a different (e.g., new) RAN area, tracking area, cell group, or is different than the cell on which the WTRU is camped directly on Uu. The remote WTRU may use an establishment cause (e.g., new establishment cause), for example, to indicate the reception of (e.g., one or any of) the sidelink messages. The remote WTRU may select the establishment cause based on the specific sidelink message type.

In examples, a remote WTRU (e.g., in RRC_CONNECTED) may determine (e.g., if/when suspending or releasing the bearers of the relay entity) whether to initiate an RRC message or not, e.g., based on the bearer configuration information and/or amount of data (e.g., current amount of data) on one or more bearers. For example, the remote WTRU may suspend bearers (e.g., all bearers) or bearer legs associated with the secondary path and may inform the network (e.g., trigger an RRC message, or a BSR on Uu), for example, if the amount of buffered data for at least one bearer at the time of suspension is above a threshold configured for that bearer.

In examples, a remote WTRU (e.g., in RRC_CONNECTED) may determine the type of indication to send following suspension of one or more bearers, for example, based on whether the relay WTRU is served by the same cell as the remote WTRU itself (e.g., over Uu). The remote WTRU may trigger a BSR (e.g., in the same cell case). The remote WTRU may trigger an RRC message, for example, while in the different cell case.

A remote WTRU may suspend or release one or more bearers or RLC entities of a bearer.

In examples, a remote WTRU (e.g., in RRC_CONNECTED) may suspend a bearer, for example, based on reception (e.g., from a relay WTRU) of a PC5-RRC message indicating one of the events at the relay (e.g., HO, Uu RLF, etc.). The remote WTRU may (e.g., alternatively) release one or more bearers or the relay leg of a split bearer. The remote WTRU may (e.g., alternatively) move the traffic of a bearer (e.g., a split bearer) from a (e.g., one) leg to another leg. The remote WTRU may (e.g., alternatively) change a split bearer to a (e.g., single) leg bearer. Whether/which operation(s) to perform at the remote WTRU may depend on the type of message received. The remote WTRU may suspend a bearer associated with the relayed path or suspend the RLC leg of a split bearer, for example, based on reception of a HO indication or cell reselection indication from the relay WTRU. The remote WTRU may keep the bearer suspended, for example, until reception of network reconfiguration information. The remote WTRU may release the bearer or change the split bearer to a single leg bearer, for example, based on reception of an indication by the relay WTRU that the relay failed connection establishment or a Uu RLF may be received.

In examples, the remote WTRU may refrain from suspending (e.g., not suspend) the bearer or refrain from re-establishing (e.g., not re-establish) the layer(s) (e.g., any of the layers), for example, based on reception of a HO indication from the relay WTRU. The remote WTRU may suspend the bearer and perform RLC entity re-establishment (e.g., at some later time or event as described herein, for example, such as reception of a reconfiguration message. For example, the remote WTRU may suspend the bearer and perform RLC entity re-establishment based on an indication of failure to establish an RRC connection or Uu RLF. Whether the remote WTRU continues to perform transmission, for example, refrains from suspending the bearers or does not suspend the bearers may depend on the cell (e.g., new cell) served by the relay following the HO. The remote WTRU may suspend the bearers or RLC legs transmitted over the relayed path, for example, if the cell (e.g., new cell) becomes the same as the cell served by the remote WTRU via Uu.

The remote WTRU may change the primary path of a bearer (e.g., SRB or DBR). A WTRU may change the primary path of a bearer, for example, based on (e.g., upon) reception of a MessageTransferSidelink from the relay WTRU. The remote WTRU may change (e.g., all) bearers configured as split bearers so that the primary path may be Uu, for example, based on (e.g., upon) reception of an indication of a backhaul RLF indication, a HO/cell reselection, or a connection establishment failure. The remote WTRU may (e.g., alternatively) change the primary path of certain bearers (e.g., SRB only, DRB having certain QoS characteristics only, etc) to Uu. Whether the WTRU changes the primary path may (e.g., further) depend on the type of message. The primary path may not be changed, for example, for HO and cell reselection. The primary path may be changed, for example, for Uu RLF and relay connection establishment failure. Whether the WTRU changes the primary path or not may depend on whether the cell ID associated with the relay WTRU changes to a different configured group, ran area, etc. The WTRU may maintain the primary path of a bearer, for example, if the cell ID stays within the same configured group, or if the cell ID of the relay and the remote WTRU are within the same group following the HO/reselection signaled by the relay WTRU.

The remote WTRU may transmit a re-establishment request or initiate a procedure (e.g., re-establishment-like procedure) to the NW on Uu.

A WTRU may transmit a re-establishment request to the NW on Uu, for example, following reception of a message from the network. The remote WTRU may initiate a legacy re-establishment procedure, for example, without cell selection (e.g., assuming the selected cell may be the cell associated with the direct Uu path before reception of the message from the relay). The remote WTRU may perform the procedure (e.g., a (e.g., only)) based on satisfying one or more (e.g., specific) conditions, such as one or a combination of the following: the primary path of SRB1 was over the relayed path; the relay WTRU message indicates a HO for which the (e.g., new) cell (e.g., on the relayed path) may be different than the cell on the direct path; the relay WTRU message indicates a HO for which the (e.g., new) cell (e.g., on the relayed path) may be part of a different cell group compared to the cell on the direct path; the cells on the direct and indirect path are the same or different prior to reception of the message; the WTRU communicates to the PCell via the relayed path prior to the reception of the message from the relay WTRU; etc.

The WTRU may transmit an RRC message (e.g., another RRC message) (e.g., such as an RRC message informing the network of the relay message, as discussed herein), for example, if the WTRU decides not to transmit a re-establishment request to the network or to initiate a re-establishment like procedure.

In examples, combinations of the examples (e.g., as described herein) may be performed.

A relay WTRU may provide additional information to the remote WTRU for bearer reconfiguration or recovery.

In examples, a relay WTRU may include additional information about an event associated with the UuMessageTransferSidelink (e.g., HO, Uu RLF, etc). Such information may be used by the remote WTRU for bearer reconfiguration or recovery actions, for example, while the remote WTRU may be in RRC_CONNECTED. The relay WTRU may derive such information, for example, based on information obtained from the network at (e.g., each of) the indicated event(s) (e.g., in the HO command). The relay WTRU may include (e.g., in a message) one or more of the following: security information; re-establish/reset information; adaptation layer reconfiguration information; etc.

The relay WTRU may include (e.g., in a message) security information, for example, such as security keys, keying information, or an indication of whether the mobility event by the relay WTRU resulted in a change in the keys at the relay WTRU. For example, a relay WTRU that receives a HO command from the network may provide an indication in PC5-RRC of whether the relay WTRU received the masterKeyUpdate in the HO command. The remote WTRU may use this indication to determine whether or not to re-establish the PDCP. The remote WTRU may re-establish the PDCP, for example, if the relay WTRU indicates that it received the masterKeyUpdate. Otherwise, the remote WTRU may re-establish the RLC and reset the MAC without re-establishing the PDCP.

The relay WTRU may include (e.g., in a message) re-establish/reset information. For example, a relay WTRU may determine (e.g., following a HO) whether to re-establish RLC (e.g., whether it needs to re-establish RLC). The relay WTRU may inform the remote WTRU in UuMessageTransferSidelink (e.g., by including a flag to the remote WTRU), for example, if the relay WTRU determines to re-establish RLC. The remote WTRU may re-establish one or more protocol layers (e.g., re-establish PDCP, and RLC), for example, based on reception of such indication.

The relay WTRU may include (e.g., in a message) adaptation layer reconfiguration information. A relay WTRU may receive reconfiguration information of the adaptation layer, for example, in the HO command. The relay WTRU may determine whether the reconfiguration information in the adaptation layer affects the remote WTRU. If the reconfiguration information in the adaptation information affects the remote WTRU, the relay WTRU may indicate this to the remote WTRU. The remote WTRU may re-establish one or more protocol layers and/or transmit a PDCP status report, for example, based on reception of such indication by the remote WTRU.

The relay WTRU may transmit an indication (e.g., explicit indication) to the remote WTRU, for example, to trigger the remote WTRU to re-establish a protocol layer and/or transmit a status report. The relay WTRU may (e.g., alternatively) transmit information used (e.g., required) by the remote WTRU for the re-establishment. The remote WTRU may determine to perform re-establishment, rekeying, status report, etc., for example, if (e.g., when) such information is included in the PC5-RRC message.

The WTRU may initiate re-establishment following a failed path addition.

In examples, a WTRU may initiate a re-establishment procedure following a failed path addition. For example, a remote WTRU configured with indirect path may receive (e.g., only receive) a direct path addition. The remote WTRU may trigger a re-establishment procedure (e.g., possibly triggered on the indirect path), for example, if the direct path addition fails (e.g., RACH failure, no acknowledgment received to complete message, etc.). The WTRU may (e.g., further) determine whether to initiate a re-establishment procedure, for example, depending on the cell ID associated with the path being added. The remote WTRU may trigger re-establishment based on a failure of the path addition, for example, if the direct path being added has a cell ID different than the indirect path cell ID. Otherwise, if the cell ID may be the same, the remote WTRU may send another RRC message, or may send no RRC message, following direct path addition failure.

Re-establishment procedure may depend on path selected and/or cell relationship.

In an example, a remote WTRU configured with multipath that triggers re-establishment may perform a path dependent re-establishment procedure. Re-establishment (e.g., actions performed in re-establishment) may depend on whether the WTRU selects a relay WTRU to perform re-establishment via the relay or selects a cell and performs re-establishment via a direct Uu. Re-establishment (e.g., alternatively) may depend on whether the same or different cell may be configured on the direct and indirect paths. The processes (e.g., actions) performed in re-establishment, which may be different, may include one or more of the following: whether the WTRU releases the PC5-RRC connection; whether the WTRU selects the best cell/relay (e.g., based on criteria) or any cell/relay which meets a suitability criterion (e.g., RSRP above a threshold); whether the WTRU initiates CHO (e.g., if a CHO candidate may be configured) or not; whether the WTRU releases the multipath configuration or not; whether to exclude a relay in the relay/cell selection; etc.

For example, the remote WTRU may release the PC5-RRC connection, for example, if re-establishment results in selecting a different relay WTRU. The remote WTRU may maintain the PC5-RRC connection, for example, if the remote WTRU selects a cell to perform re-establishment via the Uu.

The remote WTRU may release the PC5-RRC connection, for example, if the cell selected during the re-establishment procedure may be different than the PCell when re-establishment was triggered. The remote WTRU may maintain the PC5-RRC connection, for example, if the selected cell may be the same as the PCell when re-establishment was triggered, or if the selected cell may be the same as the cell serving the relay path.

In examples, the remote WTRU may trigger re-establishment and perform relay/cell selection. In the relay/cell selection, the remote WTRU may prioritize relay selection to the same relay. The remote WTRU may maintain the PC5-RRC connection during cell/relay reselection. If the remote WTRU selects the same relay WTRU, the PC5-RRC connection may be already established. In such case, there may be no need to tear down the PC5-RRC connection. The remote WTRU may prioritize the same relay WTRU by selecting the relay as long as the relay measurements are above a threshold (e.g., even if other cells/relays have better measurements).

A remote WTRU may exclude (e.g., in the relay/cell selection) selecting (e.g., refrain from selecting) the same relay WTRU as was previously connected via the PC5-RRC connection while in multipath, for example, if the relay WTRU may be still connected to the same cell as prior to the trigger of re-establishment. The remote WTRU may further perform such exclusion based on conditions related to the cause of the re-establishment (e.g., the re-establishment was triggered while the remote WTRU received an indication of Uu RLF from the relay WTRU and the relay WTRU may be still served by the same cell).

The remote WTRU may inform the network during the re-establishment of whether the PC5-RRC connection was maintained from a previous connection, and the specific relay WTRU associated with the PC5-RRC connection.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-14. (canceled)

15. A remote wireless transmit/receive unit (WTRU), the remote WTRU comprising:
a processor configured to:
receive, from a network, a reconfiguration message via Uu signaling, wherein the reconfiguration message indicates to establish a connection with a relay WTRU via an indirect path, and wherein the reconfiguration message comprises signaling radio bearer (SRB) configuration information;
determine an SRB configuration associated with the remote WTRU based on the SRB configuration information, wherein the SRB configuration is one of a split SRB configuration or a non-split SRB configuration; and
based on the determined SRB configuration, send a transmission to the relay WTRU, wherein on a condition that the SRB configuration is the non-split SRB configuration, the transmission comprises a PC5-RRC message that indicates to the relay WTRU to initiate a RRC connection with the remote WTRU.

16. The WTRU of claim 15, wherein on a condition that the SRB configuration is the split SRB configuration, the transmission comprises a Uu message that indicates Uu reconfiguration is complete.

17. The WTRU of claim 15, wherein the transmission to the relay WTRU is a first transmission, and wherein the processor is further configured to:
send a second transmission to the network via a direct path, wherein the second transmission comprises a Uu message that indicates Uu reconfiguration is complete.

18. The WTRU of claim 17, wherein the first transmission comprises the PC5-RRC message that indicates to the relay WTRU to initiate the RRC connection with the remote WTRU.

19. The WTRU of claim 17, wherein the first transmission comprises a Uu message that indicates Uu reconfiguration is complete, and wherein the second transmission comprises a duplicate Uu message that indicates Uu reconfiguration is complete.

20. The WTRU of claim 15, wherein the transmission sent to the relay WTRU is further based on the received reconfiguration message indicating to establish connection with the relay WTRU via the indirect path.

21. The WTRU of claim 15, wherein the split SRB configuration is associated with enabling sending a Uu message via the indirect path, wherein the Uu message indicates Uu reconfiguration is complete.

22. The WTRU of claim 15, wherein the non-split SRB configuration is associated with enabling sending the Pc5-RRC message via the indirect path.

23. The WTRU of claim 15, wherein the SRB configuration information is per-bearer configuration information.

24. A method comprising:
receiving, from a network, a reconfiguration message via Uu signaling, wherein the reconfiguration message indicates to establish a connection with a relay wireless transmit/receive unit (WTRU) via an indirect path, and wherein the reconfiguration message comprises signaling radio bearer (SRB) configuration information;
determining an SRB configuration associated with a remote WTRU based on the SRB configuration information, wherein the SRB configuration is one of a split SRB configuration or a non-split SRB configuration; and
based on the determined SRB configuration, sending a transmission to the relay WTRU, wherein on a condition that the SRB configuration is the non-split SRB configuration, the transmission comprises a PC5-RRC message that indicates to the relay WTRU to initiate a RRC connection with the remote WTRU.

25. The method of claim 24, wherein on a condition that the SRB configuration is the split SRB configuration, the transmission comprises a Uu message that indicates Uu reconfiguration is complete.

26. The method of claim 24, wherein the transmission to the relay WTRU is a first transmission, and wherein method further comprises:
sending a second transmission to the network via a direct path, wherein the second transmission comprises a Uu message that indicates Uu reconfiguration is complete.

27. The method of claim 26, wherein the first transmission comprises the PC5-RRC message that indicates to the relay WTRU to initiate the RRC connection with the remote WTRU.

28. The method of claim 26, wherein the first transmission comprises a Uu message that indicates Uu reconfiguration is complete, and wherein the second transmission comprises a duplicate Uu message that indicates Uu reconfiguration is complete.

29. The method of claim 24, wherein the transmission sent to the relay WTRU is further based on the received reconfiguration message indicating to establish connection with the relay WTRU via the indirect path.

30. The method of claim 24, wherein the split SRB configuration is associated with enabling sending a Uu message via the indirect path, wherein the Uu message indicates Uu reconfiguration is complete.

31. The method of claim 24, wherein the non-split SRB configuration is associated with enabling sending the Pc5-RRC message via the indirect path.

32. The method of claim 24, wherein the SRB configuration information is per-bearer configuration information.
